(19) United States
(12) Patent Application Publication
(10) Pub. No.: US 2024/0335793 A1
(43) Pub. Date: Oct. 10, 2024

(54) EXTRACTION OF AMMONIA AND SULFURIC ACID FROM AMMONIUM-SULFATE-RICH (WASTE) WATERS

(71) Applicant: Evonik Operations GmbH, Essen (DE)

(72) Inventors: Felix STOCKMEIER, Hanau (DE); Silvia BLANK-SHIM, Aschaffenburg (DE); Patrik STENNER, Hanau (DE); Tobias WINKLER, Dülmen (DE); Rainer STAHL, Arnsberg (DE); Jörg-Joachim Nitz, Essen (DE)

(73) Assignee: Evonik Operations GmbH, Essen (DE)

(21) Appl. No.: 18/626,602

(22) Filed: Apr. 4, 2024

(30) Foreign Application Priority Data
Apr. 5, 2023 (EP) 23166752.8

(51) Int. Cl. B01D 61/46; B01D 61/44; B01D 61/54; C01B 17/74; C01C 1/02

(52) U.S. Cl. CPC B01D 61/465; B01D 61/445; B01D 61/54; C01B 17/745; C01C 1/028

(57) ABSTRACT

The invention relates to the electrodialytic production of ammonia and sulfuric acid from ammonium-sulfate-rich (waste) waters. An object of said invention was to provide a process for recovering ammonia and sulfuric acid from waters containing ammonium sulfate in high concentrations. The process should be practicable on an industrial scale and have good energy efficiency. This problem is solved by a combination of electrodialysis and water electrolysis. It results in ammonium sulfate being split back into ammonia and sulfuric acid. Unlike conventional three-chamber processes, the process of the invention employs a cell having only two compartments, which can however be multiply parallelized within the stack. This type of scale-up is much more cost-effective than connecting multiple cells in parallel.

The invention relates to the electrodialytic production of ammonia and sulfuric acid from ammonium-sulfate-rich (waste) waters.

Ammonium sulfate (NH₄)₂SO₄ is a nitrogen fertilizer used in traditional agriculture and horticulture. However, the ammonium sulfate used for this is generally not specifically produced, but mostly arises as a by-product in large-scale chemical processes that use ammonium compounds as starting material, such as in the production of caprolactam or hydrogen cyanide. In this case, however, it is generally not in solid form (as the salt), but dissolved in water. Where the water does not contain any other production residues besides ammonium sulfate, ammonium-sulfate-containing wastewaters have in the past been sold to agriculture and applied to fields as fertilizer.

An overview of the properties, production and use of ammonium sulfate is given by:
Zapp, K.-H., Wostbrock, K.-H., Schäfer, M., Sato, K., Seiter, H., Zwick, W., Creutziger, R. and Leiter, H. (2000). Ammonium Compounds. Section 2: Ammonium Sulfate. In Ullmann's Encyclopedia of Industrial Chemistry, (ed.). DOI: 10.1002/14356007.a02_243

Rising levels of nitrates in groundwater caused by increasing over-fertilization of fields has led to increasing regulation of the application of nitrogen fertilizers in the European Union. As a consequence, the scope for agricultural use of production wastewater containing ammonium sulfate is diminishing.

However, since such wastewaters continue to accumulate in plants processing ammonium compounds, alternative means of reusing these wastewaters are being sought.

A starting point for this is the recovery of the ammonium sulfate present in the wastewater. The reaction of ammonia and sulfuric acid to ammonium sulfate is reversible, which means that with an input of energy it is possible to convert the ammonium sulfate back into ammonia and sulfuric acid. The substances recovered in this way could then be reused as reactants in the chemical plants that produce the ammonium-sulfate-containing wastewaters.

It was therefore an object of the invention to develop a process that permits the industrial-scale recovery of ammonia and sulfuric acid from wastewaters containing ammonium sulfate.

It is already known that ammonium salts can be removed from water by electrochemical means, or more precisely by electrodialysis.

Electrodialysis is a membrane separation method in which the ionic constituents of an electrolyte are separated on at least one selectively ion-conducting membrane within an electric field.

There are three types of ion-conducting membrane: anion-conducting membranes (anion exchange membrane—AEM), cation-conducting membranes (cation exchange membrane—CEM) and bipolar membranes (BPM). An AEM has better ion conductivity for anions than for cations. It is ionically positively charged. A CEM has better ion conductivity for cations than for anions. It is ionically negatively charged. A BPM has an ionically positively charged portion and an ionically negatively charged portion. A BPM conducts both anions and cations, but in different directions. Its purpose is to split water molecules diffusing into the BPM into base anions and acid cations at the contact surface of the ionically positively charged portion and of the ionically negatively charged portion when an electric field is applied. As a result of the transport of these ions to the adjoining media, a pH gradient is generated across the BPM. On the side facing the ionically positively charged portion, a basic environment with a high pH develops and on the side facing the ionically negatively charged portion, an acidic environment with a low pH develops.

Ion-conducting membranes usually consist of special fluorinated or sulfonated polymers. Well-known examples are the Nation® membranes from DuPont. There are however also ceramic ion-conducting membranes.

The electrochemical cells used in electrodialysis generally combine a plurality of selectively ion-conducting membranes of different types into a stack. Within a stack, the same sequence of membrane types, which is referred to as a repeating unit, can be multiply parallelized.

Depending on the number of electrolytes separately present in the cell, a distinction is made between two-chamber cells and three-chamber cells. Two-chamber cells operate with two electrolytes, whereas three-chamber cells additionally have a third electrolyte.

A brief introduction to electrodialysis is given by:
Van der Bruggen, B. (2017). Membrane Technology. Section 7.5 Electrodialysis. In Kirk-Othmer Encyclopedia of Chemical Technology, John Wiley & Sons, Inc (ed.).
DOI: 10.1002/0471238961.1305130202011105.a01.pub3

An electrodialytic process for removing ammonium chloride from water has been described for example in CN104445755B. The method disclosed therein uses bipolar membranes and permits conversion of ammonium chloride present in the water in concentrations of up to 2 mol/L ammonium chloride.

It is not known to what extent the membranes used in CN104445755B are resistant to ammonium sulfate. Moreover, the relevant wastewaters from plants processing NH₃ contain significantly higher concentrations of ammonium that can be up to 6 mol/L. Therefore, the wastewater would have to first be diluted before it could be treated by the process described in CN104445755B. This appears uneconomic.

A combined electrolytic and electrodialytic process for removing ammonium nitrate was proposed by Gain et al.:
Gain, E., Laborie, S., Viers, P. et al. Ammonium nitrate wastewater treatment by coupled membrane electrolysis and electrodialysis. Journal of Applied Electrochemistry 32, 969-975 (2002). DOI: 10.1023/A: 1020908702406

The ammonia liberated is removed from the electrolyte by stripping with air. The concentrations of ammonium nitrate are here too quite low. In addition, Gain et al. concerns a different substance system.

The papers by Lv et al. and Li et al. both describe electrodialytic batch experiments with stacks consisting of alternating anion-exchange membranes and bipolar membranes.
Yan Lv, Haiyang Yan, Baojun Yang, Cuiming Wu, Xu Zhang, Xiaolin Wang: Bipolar membrane electrodialysis for the recycling of ammonium chloride wastewater: Membrane selection and process optimization. Chemical Engineering Research and Design, volume 138, 2018, pages 105-115, ISSN 0263-8762. DOI 10.1016/j.cherd.2018.08.014.
Ya Li, Shaoyuan Shi, Hongbin Cao, Xinmin Wu, Zhijuan Zhao, Liying Wang: Bipolar membrane electrodialysis for generation of hydrochloric acid and ammonia from simulated ammonium chloride wastewater. Water Research, volume 89, 2016, pages 201-209,
ISSN 0043-1354, DOI: 10.1016/j.watres.2015.11.038.

However, the concentrations of the ammonium salts are here too quite low and in both cases it is not ammonium sulfate, but ammonium chloride.

Finally, a number of approaches for the electrodialytic enrichment of ammonium using three-chamber cells have emerged, for example from JP2011224445A, from CN102515317A and from US 2021/0069645 A. The three-chamber cells comprise a stack composed of bipolar membrane, anion-exchange membrane, cation-exchange membrane and bipolar membrane. They thus form three compartments: a first, acidic compartment between the bipolar membrane and anion-exchange membrane, a second, central compartment between the anion-exchange membrane and cation-exchange membrane, and a third, basic compartment between the cation-exchange membrane and bipolar membrane. In most systems, the chambers, which are located directly at the electrodes, are in addition rinsed with a separate electrolyte, the electrode rinse solution. The feed is stripped of its salts in the central compartment between the anion-exchange membrane and the cation-exchange membrane. Acid forms in the acidic compartment, whereas the basic compartment becomes enriched with ammonium.

The disadvantage of three-chamber cells compared to two-chamber cells is that, because of the complex structure of their stack, they have a fairly high internal electrical resistance and therefore their operating principle necessitates higher voltages in order to separate the same molar amount of material as a two-chamber cell. The electrical energy requirement of a three-chamber cell is therefore higher than that of a two-chamber cell for the same separation performance.

In addition, the use of a feed with a high concentration of the substances to be separated results in higher concentration gradients in a three-chamber cell structure compared to a two-chamber cell structure. In a three-chamber cell structure this results in significant transport of water due to osmosis from a compartment with a low concentration to an adjoining one with a higher concentration, which is a further challenge associated with the process.

The removal of ammonium sulfate from wastewaters by electrodialysis has been described by Yang et al.:
Yang, H., Zhang, X.-S. and Yuan, W.-K. (2008), Effect of Operating Parameters on the Condensation of Ammonium Sulfate by Electrodialysis. Chem. Eng. Technol., 31:1261-1264. https://doi.org/10.1002/ceat.200700461

The recovered target product was ammonium sulfate.

DE 2727409 C2 discloses the electrodialysis of ammonium sulfate to ammonia and sulfuric acid by means of a three-chamber cell having a stack that comprises an anion-exchange membrane and a cation-exchange membrane. In the examples, a 6% (NH₄)₂SO₄ solution is pumped into the cell. This corresponds to approximately 0.45 mol/l. The disadvantages of this process are those discussed above in general terms for three-chamber cells. Furthermore, scaling up this setup for larger (waste) water flows appears possible only by enlarging the membrane and electrode surface area or by connecting many identical modules in parallel.

Luo et al also describe an electrodialysis of ammonium sulfate to ammonia and sulfuric acid by means of a three-chamber cell having a stack that comprises a first bipolar membrane, an anion-exchange membrane, a cation-exchange membrane and a second bipolar membrane:
Luo Mingrui, Zhang Zeqiang, Zhang Hanquan, Li Donglian, He Dongsheng: Influence factors of decomposing ammonium sulfate by bipolar membrane electrodialysis Chemical Minerals and Processing. 2015, 44 (11) DOI: 10.16283/j.cnki.hgkwyjg.2015.11.007

Luo et al. investigated the decomposition of ammonium sulfate having a concentration of up to 1061 mol/l.

The production of sulfuric acid from ammonium sulfate by means of a two-chamber cell with a stack comprising a first bipolar membrane, an anion-exchange membrane and a second bipolar membrane was described by Gao:
Gao Li-hua, Study on Sulfuric acid Production from Ammonium sulfate by Bipolar Membrane Electrodialysis, HeBei HuaGong, vol 35, No. 6, June 2012.

However, this process did not produce any ammonia.

An electrodialytic process for removing ammonia from water was extensively investigated by van Linden et al.:
Niels van Linden, Henri Spanjers, Jules B. van Lier: Application of dynamic current density for increased concentration factors and reduced energy consumption for concentrating ammonium by electrodialysis. Water Research, volume 163, 2019, 114856, ISSN 0043-1354, DOI: 10.1016/j.watres.2019.114856.

A special feature in the electrochemical treatment of ammonium-containing wastewaters is that the ammonia formed by pH shift is present as an uncharged molecule dissolved in the water. As an uncharged, small molecule, ammonia is able to pass through ion-exchange membranes swollen with water, and diffuses into the electrolytes in the other chambers as a result of concentration gradients. The amount of ammonia that diffuses depends here on the residence time. This undesired effect is particularly highly pronounced when ammonium is present in high concentrations in the wastewater.

In an acidic environment, the dissociation equilibrium shifts back to the side of ammonium, which on account of its charge is able to pass only through cation-exchange membranes. This association makes it necessary for the target product ammonia produced in the electrodialysis to be removed from the basic electrolyte after the shortest possible residence time.

Furthermore, ammonia has very good solubility (531 g/L at 20° C.) in water, which means that high concentrations can be attained without spontaneous outgassing. This heightens the need for the swiftest possible removal downstream of the electrodialysis.

In the light of this prior art, the object of the invention was to provide a process for recovering ammonia and sulfuric acid from waters containing ammonium sulfate in high concentrations. The process should be practicable on an industrial scale and have good energy efficiency.

This object is achieved by a process having the following, non-chronological steps:
a) providing at least one electrochemical cell having the following features:
   i) the electrochemical cell includes an anodic electrode chamber in which an anode is arranged;
   ii) the electrochemical cell includes a cathodic electrode chamber in which a cathode is arranged;
   iii) the electrochemical cell includes a stack having the following structure:
      the stack has repeating units, the number of repeating units is exactly n, where n is a natural number;
      the stack has primary compartments, the number of primary compartments is exactly n;
      the stack has secondary compartments, the number of secondary compartments is exactly n;
      the stack has separators, the number of separators is exactly s,
      where s is calculated as follows: s=2*n−1;
      the primary and secondary compartments are arranged alternately in the stack and are each separated from one another by a separator;
      each separator is either an anion-conducting membrane or a bipolar membrane;
      the number a of separators that are an anion-conducting membrane is determined as follows:
      a=1 when n=1, and a=n−1 when n>1;
      the number b of separators that are a bipolar membrane is determined as follows:
      b=0 when n=1, and b=n when n>1;
      when n>1, the separators that are an anion-conducting membrane and the separators that are a bipolar membrane are arranged alternately within the stack;
      each primary compartment is arranged on the anode side of an adjoining bipolar membrane, where the adjoining bipolar membrane does not need to be part of the stack;
      each secondary compartment is arranged on the cathode side of an adjoining bipolar membrane, where the adjoining bipolar membrane does not need to be part of the stack;
   iv) the electrochemical cell includes two end membranes, the first end membrane being arranged between the stack and anodic electrode chamber, the second end membrane being arranged between the stack and the cathodic electrode chamber, both end membranes being identically selected from the group consisting of the following membrane types: anion-conducting membrane, cation-conducting membranes, bipolar membrane;
   v) each bipolar membrane is arranged in the electrochemical cell such that its positively charged portion is facing towards the anode, while its negatively charged portion is facing towards the cathode;
b) providing an electrical voltage source;
c) providing an ammonium-sulfate-rich water comprising water and ammonium sulfate;
d) providing an acidic electrolyte comprising water and sulfuric acid;
e) providing an electrode rinse solution comprising water, sulfuric acid and/or ammonium sulfate;
f) charging the primary compartments of the electrochemical cell with the ammonium-sulfate-rich water;
g) charging the secondary compartments of the electrochemical cell with the acidic electrolyte;
h) rinsing the electrode chambers with electrode rinse solution;
i) charging the electrochemical cell with an electrical voltage drawn from the electrical voltage source such that there is an electrical potential between the anode and the cathode;
j) discharging ammonia water from the primary compartments of the electrochemical cell;
k) discharging aqueous sulfuric acid from the secondary compartments of the electrochemical cell;
l) removing ammonia from the ammonia water, affording an ammonia-depleted water.

The invention provides such a process.

The process of the invention is a combination of electrodialysis and water electrolysis. It results in ammonium sulfate being split back into ammonia and sulfuric acid.

Unlike conventional three-chamber processes, the process of the invention employs a cell having only two compartments, which can however be multiply parallelized within the stack. This type of scale-up is much more cost-effective than connecting multiple cells in parallel. In addition, the cell structure of the invention enables the ammonium to have only a short residence time in the cell, which means that the ammonium does not have enough time to diffuse back through the membranes into other compartments or into the electrode chambers. The setup of the invention also permits swift removal of the ammonia.

By virtue of the special stack structure it is also possible to process water that has a very high ammonium sulfate content, which is generated on a global scale in the production of ammonium-based chemicals.

Preferably, the electrochemical cell has exactly one anodic electrode chamber, exactly one cathodic electrode chamber, exactly one stack and exactly two end membranes, and the first end membrane directly adjoins the stack and anodic electrode chamber and the second end membrane directly adjoins the stack and cathodic electrode chamber. By dispensing with further elements, the cell structure becomes very effective.

In particular, the stack consists of the compartments and separators listed above. This means that the stack comprises no further elements other than those listed above.

However, it is also possible for the compartments or the electrode chambers to be spanned by a spacer. A spacer is a placeholder that keeps the free space in the compartments or in the electrode chambers open. Since the spacer has no electrochemical effect, it is not a separate element of the stack. Rather, a spacer should be understood as being part of the electrode chamber or compartments.

Preferably, scale-up is accomplished by increasing the number of repeating units in the stack. In addition, a numbering-up is also conceivable. In that case, a system for executing the process comprises a large number of electrochemical cells connected to the electrical voltage source in parallel.

The ammonia formed in the process is discharged from the cell with the ammonia water. The removal of the ammonia gas from the ammonia water liquid is preferably accomplished by stripping with air or nitrogen.

In a particularly preferred embodiment of the invention, ammonia is removed from the ammonia water under reduced pressure or vacuum, i.e. at a pressure of between 0 hPa and 1013 hPa. At reduced pressure, the ammonia escapes almost on its own, which means that less stripping gas is needed. However, stripping with stripping gas is also possible at reduced pressure. This does not require such a strong vacuum.

The process is preferably carried out in one of the following operating modes: batch, semi-batch, feed-and-bleed and single pass.

In the batch operating mode, the ammonium-sulfate-rich water is provided in a primary reservoir vessel, and the ammonia-depleted water is transported to the primary reservoir vessel; and/or the acidic electrolyte is provided in a secondary reservoir vessel, and the aqueous sulfuric acid is transported to the secondary reservoir vessel. The batch process is particularly easy to execute.

A more economical option is however the semi-batch process, in which effective operating conditions are exploited for longer. In this case, the ammonium-sulfate-rich water is provided in a primary reservoir vessel, the ammonia-depleted water is transported to the primary reservoir vessel, and a portion of the contents of the primary reservoir vessel is from time to time withdrawn and replaced with fresh ammonium-sulfate-rich water; and/or the acidic electrolyte is provided in a secondary reservoir vessel, the aqueous sulfuric acid is transported to the secondary reservoir vessel, and a portion of the contents of the secondary reservoir vessel is from time to time withdrawn and replaced with fresh acidic electrolyte or water.

A particularly preferred operating mode is “feed-and-bleed”, which is characterized in that
the ammonium-sulfate-rich water is provided in a primary reservoir vessel, that the ammonia-depleted water is transported to the primary reservoir vessel, and that a portion of the contents of the primary reservoir vessel is continuously withdrawn and replaced with fresh ammonium-sulfate-rich water;
and/or that a portion of the ammonia-depleted water is ahead of transportation to the primary reservoir vessel continuously withdrawn and replaced with fresh ammonium-sulfate-rich water;
and/or that the acidic electrolyte is provided in a secondary reservoir vessel, that the aqueous sulfuric acid is transported to the secondary reservoir vessel, and that a portion of the contents of the secondary reservoir vessel is continuously withdrawn and replaced with fresh acidic electrolyte or water and/or that a portion of the aqueous sulfuric acid is ahead of transportation to the primary reservoir vessel continuously withdrawn and replaced with fresh acidic electrolyte or water.

The advantage of feed-and-bleed operation is that this mode results in the loaded ammonium having particularly short residence times in the compartments. As a result, the ammonium has no time to migrate through the membrane. This is particularly advantageous when the ammonium is run into the cell in a high concentration.

As an alternative to the cycling-based batch, semi-batch and feed-and-bleed operating processes, the process can also be operated with a non-cycling setup referred to here as “single pass”. This is characterized in that fresh ammonium-sulfate-rich water is continuously provided and ammonia-depleted water continuously discharged; and/or that fresh acidic electrolyte is continuously provided and aqueous sulfuric acid continuously discharged. The single-pass mode likewise represents a particularly preferred execution variant of the process that is of particular interest in the case of high ammonium concentrations. This is because, similarly to the feed-and-bleed mode, single-pass also involves short residence times that give the ammonium little time to cross the membrane.

Preferably, the fresh ammonium-sulfate-rich water is a water in which ammonium sulfate is present in a concentration of between 25% and 75% by weight based on the mass of the fresh ammonium-sulfate-rich water, where the pH of the fresh ammonium-sulfate-rich water measured using a glass electrode at 20° C. is between 5 and 9. These are values typical of ammonium sulfate-containing wastewaters from chemical production. Particularly preferably, the ammonium sulfate concentration of the fresh ammonium-sulfate-rich water is between 30% and 40% by weight.

30% by weight is equivalent to 2.27 mol/L. 40% by weight is equivalent to 3.03 mol/L. The molar concentrations of the ammonium ions present in the solution are then in each case twice as high. (1 mol/L of (NH₄)₂SO₄ gives rise to 2 mol/L of NH₄⁺).

In the single pass operating mode, the fresh ammonium-sulfate-containing water is run directly into the cell. In batch operation this is the case only at the beginning; in the course of batch operation, the concentration of ammonium sulfate in the ammonium-sulfate-rich water that is run into the cell falls. In semi-batch operation, the concentration of ammonium sulfate in the ammonium-sulfate-rich water is boosted again after certain intervals by replacing a portion of the contents of the primary reservoir vessel. In the feed-and-bleed process, the cell is continuously topped up with fresh ammonium-sulfate-containing water, as a result of which the content of ammonium sulfate in the ammonium-sulfate-rich water is largely constant.

Preferably, the electrode rinse solution is circulated. For this purpose, the electrode rinse solution is provided in a rinsing tank, and the electrode rinse solution is continuously run from the rinsing tank into the two electrode chambers and from there back into the rinsing tank.

Very particularly preferably, the electrode rinse solution is passed successively through one electrode chamber and then through the other electrode chamber.

Since the pH of the electrode rinse solution should be constant, the pH of the electrode rinse solution is preferably continuously monitored, with water and/or sulfuric acid metered in if the nominal pH is exceeded and/or water and/or ammonium sulfate metered in if the pH falls below it.

The amount of electrode rinse solution being circulated should likewise be constant. In order to ensure this, the filling level of the rinsing tank should be continuously monitored, with electrolyte rinse solution run off if the nominal filling level is exceeded and/or water and/or sulfuric acid and/or ammonium sulfate metered in if the filling level falls below it.

Similarly, the filling level of the reservoir vessels should also be continuously monitored, with ammonium-sulfate-rich water or acidic electrolyte run off if the nominal filling level is exceeded and/or water and/or sulfuric acid and/or ammonium sulfate metered in if the filling level falls below it.

Further preferred embodiments of the invention arise from the figure descriptions and the examples.

The basic structure of the electrochemical cell 0 used in the process of the invention will now be described with reference to the figures. The figures show in schematic form:

### BRIEF DESCRIPTION OF THE FIGURES

FIG. 1: Electrochemical cell, basic structure;

FIG. 2: Bipolar membrane in exploded view;

FIG. 3A: Stack with one repeating unit in exploded view;

FIG. 3B: Stack with two repeating units in exploded view;

FIG. 3C: Stack with three repeating units in exploded view;

FIG. 4: Electrochemical cell, charged with media;

FIG. 5: Batch operating mode;

FIG. 6: Semi-batch operating mode;

FIG. 7: Feed-and-bleed operating mode;

FIG. 8: Single pass operating mode;

FIG. 9: Electrochemical processes in the cell.

FIG. 10: Comparison of the percentage change in volume in batch experiments with Fuji versus Ralex AEMs, with in each case two repeating units.

FIG. 11: Comparison of ammonium and ammonia concentrations in batch experiments with Fuji versus Ralex AEM with in each case two repeating units.

FIG. 12: Comparison of the pH progression in batch experiments with Fuji AEMs with in each case two repeating units.

FIG. 13: Comparison of the pH progression between five and seven repeating units composed of Ralex AEMs and BPMs in semi-batch experiments.

FIG. 14: Comparison of the ammonium concentrations between 5 and 7 repeating units composed of Ralex AEMs and BPMs in semi-batch experiments.

FIG. 15: Comparison of the volume progression between five and seven repeating units composed of Ralex AEMs and BPMs in semi-batch experiments.

The electrochemical cell 0 comprises two electrode chambers 1, 2, namely an anodic electrode chamber 1 and a cathodic electrode chamber 2. Arranged in the anodic electrode chamber 1 is an anode 3 and in the cathodic electrode chamber 2 there is a cathode 4. In the two electrode chambers 1, 2 there may in addition to each electrode 3, 4 also be a spacer (not shown). A spacer is a placeholder that spans the space of the electrode chamber and keeps it open. The spacer permits the through-flow of electrode rinse solution through the electrode chambers 1, 2. More about that later. The spacer may be a porous or interwoven structure.

Arranged between the two electrode chambers 1, 2 is a stack 5, which will be described in more detail below. The stack 5 does not however directly adjoin the two electrode chambers 1, 2; instead, an end membrane 6, 7 is arranged between the stack 5 and each of the two electrode chambers 1, 2. Between the anodic electrode chamber 1 and the stack 5 there is an anodic end membrane 6 and arranged between the cathodic electrode chamber 2 and the stack 5 is a cathodic end membrane 7.

The two end membranes 6, 7 are either an anion-exchange membrane AEM, a cation-exchange membrane CEM or a bipolar membrane BPM. It is important that both end membranes 6, 7 always have the same membrane type. For example, the anodic end membrane 6 and the cathodic end membrane 7 can both be an AEM, a CEM or a BPM. A matching membrane type for the two end membranes can generally be freely chosen. Only in the case of a stack having just one repeating unit is it necessary for both end membranes 6, 7 to be a bipolar membrane BPM.

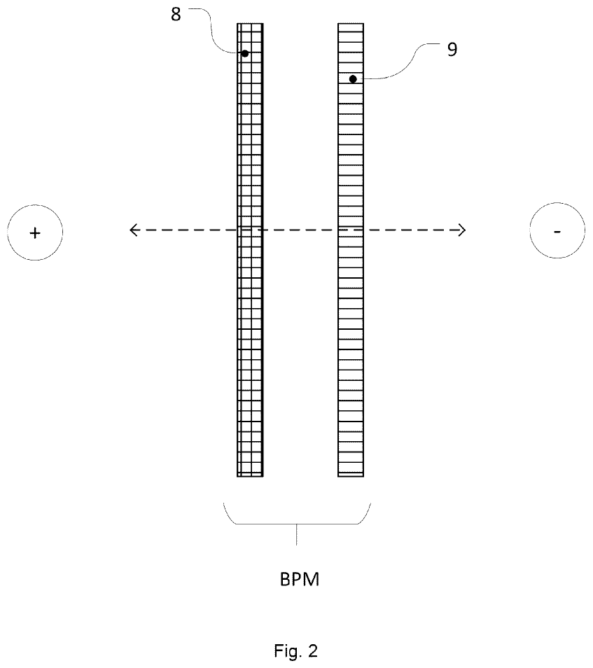

FIG. 2 shows the structure of a bipolar membrane BPM in an exploded view. A bipolar membrane BPM is a laminate consisting of a positively charged ion-exchange membrane 8 and a negatively charged ion-exchange membrane 9. The respective charge on the ion-exchange membranes 8, 9 is attained through protonation or deprotonation of the polymer from which the respective ion-exchange membranes 8, 9 are produced.

The two ion-exchange membranes 8, 9 directly adjoin one another within the bipolar membrane BPM. The distance shown in FIG. 2 is due to the exploded view. The alignment of the bipolar membrane BPM within the stack 5/within the electrochemical cell 0 is such that the positively charged ion-exchange membrane 8 is facing towards the anode 3, while the negatively charged ion-exchange membrane 9 is facing the cathode 4.

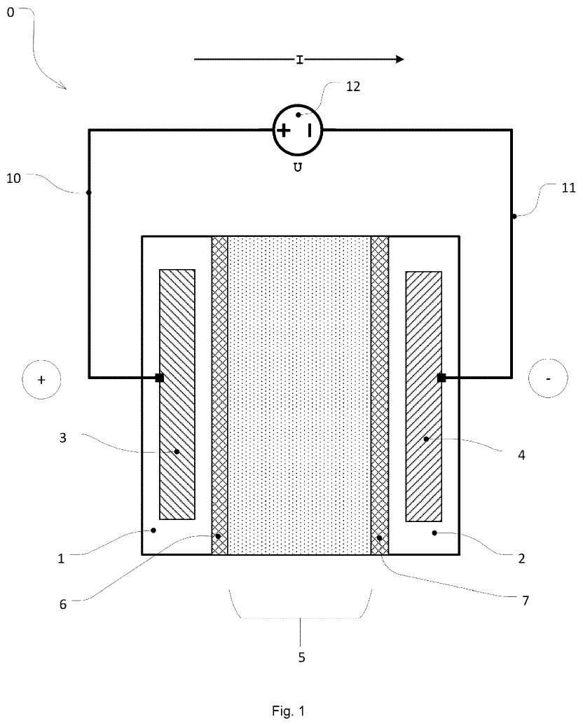

With regard to the basic structure of the electrochemical cell 0 depicted in FIG. 1, it should also be mentioned that the two electrodes 3, 4 are respectively connected via a first electrical lead 10 and via a second electrical lead 11 to an electrical voltage source 12, thereby allowing the cell 0 to be charged with an electrical voltage U drawn from the electrical voltage source 12. A corresponding electrical potential then acts between anode 3 and cathode 4. The electrical voltage source 12 is connected such that the anode 3 acts as the positive (+) terminal, while the cathode 4 forms the negative (−) terminal. During operation, an electric current/flows through the two leads 10 and 11 and the electrical voltage source 12. Since the stack 5 acts as an electrical insulator, there is no electrical short circuit between the electrodes 2, 3.

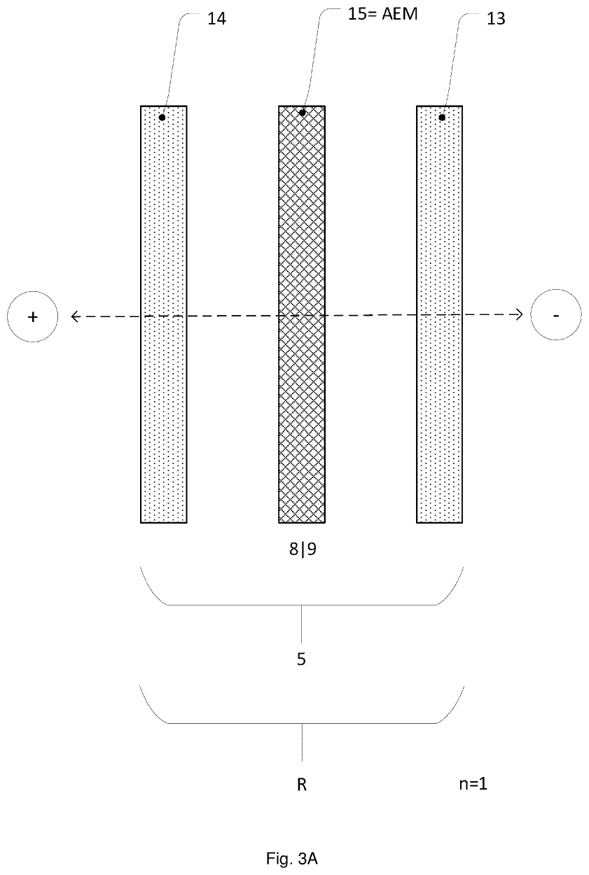

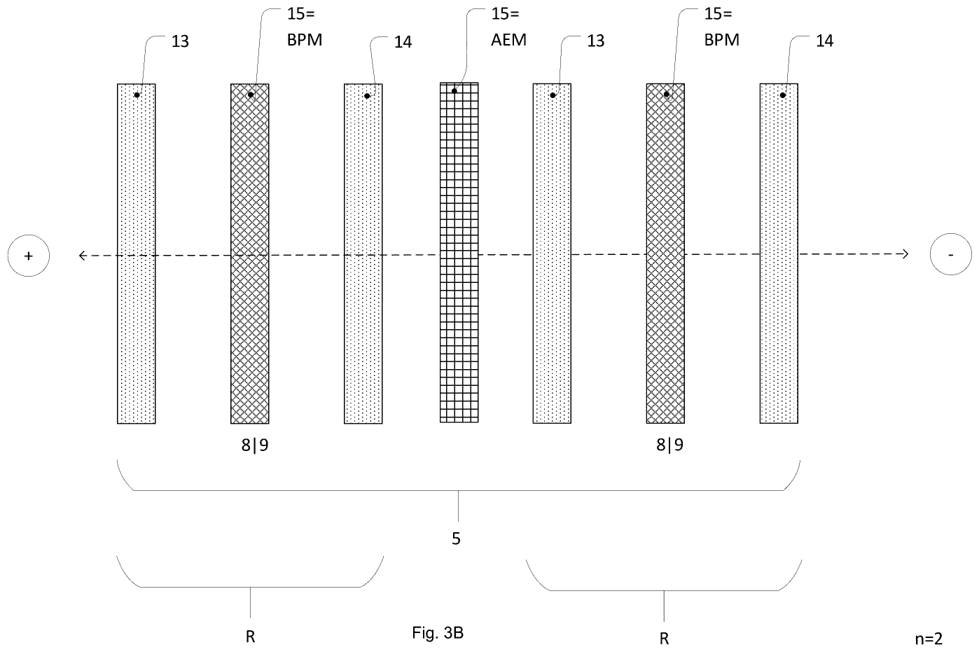

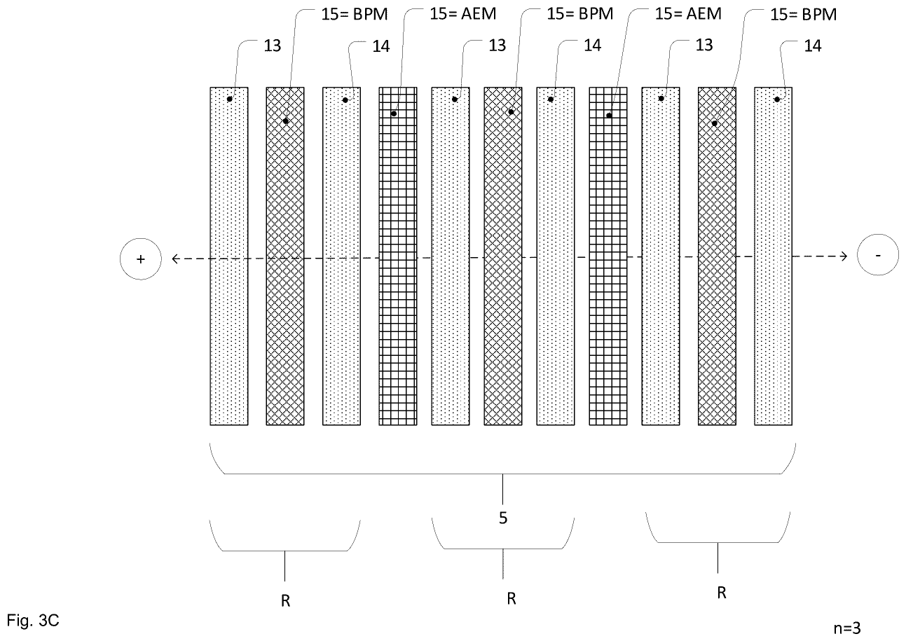

FIG. 3A shows the simplest structure of the stack 5 in an exploded view. In its simplest structure, stack 5 comprises just one repeating unit R. A repeating unit is a sequence of elements within the stack that can be repeated more than once. The sequence of elements of a repeating unit R is according to the invention as follows:
compartment-separator-compartment.

The stack is formed through the connection in sequence of a plurality of identically structured repeating units. Each element of the stack is here part of exactly one repeating unit. The number of repeating units that make up the stack is designated n. n is a natural number. Because zero is not a natural number, n is never zero. The stack therefore always has at least one repeating unit.

In the simplest form of the stack 5 depicted in FIG. 3A, the number n of repeating units is just one (n=1). This means that the stack 5 shown in FIG. 3A consists of exactly one repeating unit R.

The repeating unit comprises the following elements: a primary compartment 13, a secondary compartment 14, and a separator 15. The separator 15 is arranged between the two compartments 13, 14 and delimits the two compartments 13, 14 from one another.

The two compartments 13, 14 are spaces that are used to accommodate flowable media. More about that later. Each compartment 13, 14 can be filled by a spacer (not shown), that spans the space of the respective compartment 13, 14 and keeps it open. The spacer is for example a porous or interwoven structure that may be flooded with a fluid medium. The use of spacers facilitates the stacking of stack 5 while maintaining defined volumes in compartments 13, 14.

The separator 15 arranged between the two compartments 13, 14 must be electrically insulating and at the same time conduct ionically. Specifically, the separator 15 is an ion-conducting membrane made of an electrically insulating material. It is important that the membrane type of the separator 5 cannot be selected arbitrarily. In the simplest embodiment of the stack 5 shown in FIG. 3.1 where n=1, the separator 15 is an anion-exchange membrane AEM.

In the cell design of the invention, the primary compartment 13 must always be arranged on the anode side of a bipolar membrane BPM, while the secondary compartment 14 must always be arranged on the cathode side of a bipolar membrane BPM. Because the stack for n=1 does not contain any BPM, it is necessary to execute both end membranes as BPM. In that case, the sequence of the stack 5 for n=1 in the direction of the anode (in FIG. 3.1 towards the left) is as follows: primary compartment 13-separator 15-secondary compartment 14.

In the case of a stack having more than one repeating unit (n>1), the selected separators within the stack must alternate between an anion-exchange membrane AEM and a bipolar membrane BPM. A separator must also be arranged between two adjoining repeating units. The repeating units thus do not immediately follow one another, but are separated by a separator executed as an AEM. The end membranes can then be freely chosen.

The stack structure having exactly two repeating units R (n=2) is shown in FIG. 3B. It is in the direction of the cathode (in FIG. 3B towards the right):
primary compartment 13-separator 15 as bipolar membrane BPM-secondary compartment 14-separator 15 as anion-exchange membrane AEM-primary compartment 13-separator 15 as bipolar membrane BPM-secondary compartment 14.

For n=2, stack 5 therefore includes exactly two primary compartments 13 and exactly two secondary compartments 14. In the cell design of the invention, the number k of all compartments (anodic and cathodic) corresponds to twice the number n of repeating units (Equation 1):

$$k = 2 * n \qquad ( Eq . 1 )$$

In addition, the stack 5 for n=2 comprises three separators 15, two of which are executed as BPM and one as AEM. The separator 15 is thus alternately a bipolar membrane and an anion-exchange membrane.

In a stack structure of the invention, the number a of separators executed as AEM is determined from the number n of repeating units according to Equation 2, as follows:

$$a := \{ \begin{matrix}1 , n = 1 \\ n - 1 , n > 1\end{matrix} \qquad ( Eq . 2 )$$

In a stack structure of the invention, the number b of separators executed as BPM is determined from the number n of repeating units according to Equation 3, as follows:

$$b := \{ \begin{matrix}0 , n = 1 \\ n , n > 1\end{matrix} \qquad ( Eq . 3 )$$

From Equations 2 and 3, it follows directly that the total number s of separators in the stack is as per Equation 4:

$$s = 2 * n - 1 \qquad ( Eq . 4 )$$

FIG. 3C shows the structure of a stack 5 where n=3.

Table 1 summarizes the number of compartments k, anion-exchange membranes a, bipolar membranes b and separators s according to the number n of repeating units:

TABLE 1
Values for k, s, a and b for n < 8

| Repeating units | Compartments | Separators | AEM | BPM |
|---|---|---|---|---|
| n | k | s | a | b |
| 1 | 2 | 1 | 1 | 0 |
| 2 | 4 | 3 | 1 | 2 |
| 3 | 6 | 5 | 2 | 3 |
| 4 | 8 | 7 | 3 | 4 |
| 5 | 10 | 9 | 4 | 5 |
| 6 | 12 | 11 | 5 | 6 |
| 7 | 14 | 13 | 6 | 7 |

The number n of repeating units R within a stack can theoretically be as large as desired. Increasing the number of repeating units increases the electrochemically active surface area of the cell, thereby allowing higher throughput. However, since the internal resistance of the cell increases with the number of separators fitted, the electrical efficiency of the process decreases. There is consequently an economic optimum for the number of repeating units. More specifically, this is a function of the specific resistance of the separators and also of the cost of the membrane material.

For instance, an electrochemical cell used in the process of the invention can just as easily have 10 repeating units as 100.

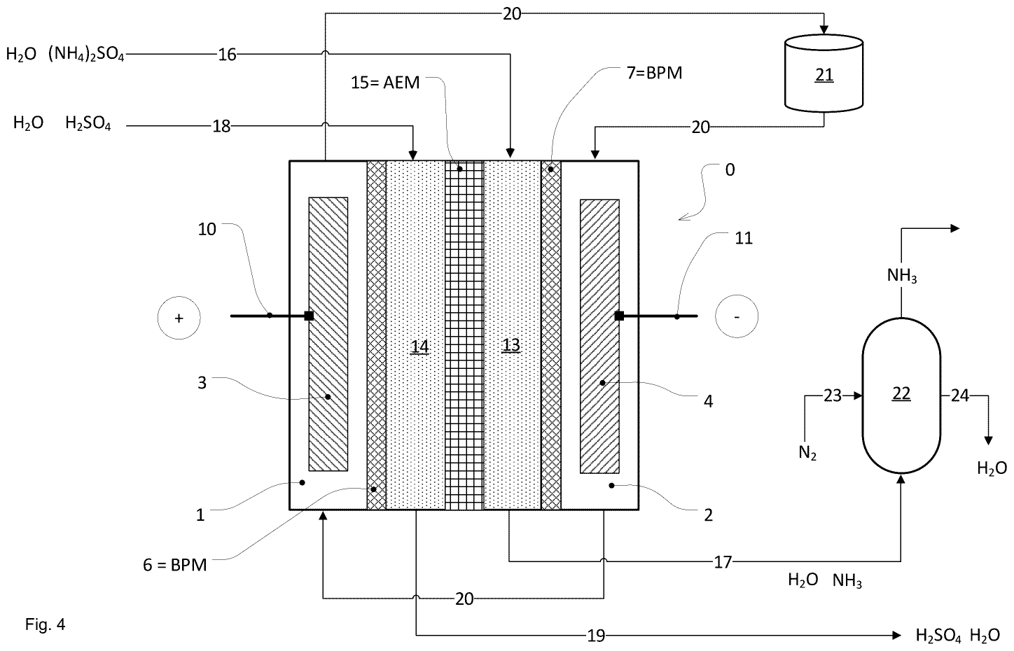

The media used to operate the electrochemical cell 0 will now be elucidated with reference to FIG. 4.

An ammonium-sulfate-rich water 16 represents the actual feed for the electrodialysis carried out in the electrochemical cell 0. It comprises water H₂O and ammonium sulfate (NH₄)₂SO₄. The ammonium-sulfate-rich water 16 is run into the primary compartment 13 of the cell 0. When the stack of the electrochemical cell 0 has more than one repeating unit (n>1), the cell also accordingly comprises n primary compartments. The ammonium-sulfate-rich water 16 is run into all primary compartments 13 present.

In the first compartment 13, the ammonium-sulfate-rich water 16 is converted into ammonia water 17. Ammonia water 17 contains water H₂O and newly formed ammonia NH₃, the ammonia being present partly in the dissociated NH₄⁺ form. The ammonia water may also contain unreacted ammonium sulfate (NH4)2SO4 (not shown). The concentration of any ammonium sulfate present in the ammonia water 17 is lower than in the ammonium-sulfate-rich water 16. The exchange of sulfate ions for hydroxide ions renders the ammonia water 17 basic. Its pH is higher than that of the ammonium-sulfate-rich water 16. The pH of the ammonia water 17 is between 9 and 14. The ammonia water 17 is an intermediate in the process and is withdrawn from the primary compartment 13.

An acidic electrolyte 18 represents an auxiliary medium for discharging the sulfuric acid formed in the process. The acidic electrolyte 18 comprises water H₂O and sulfuric acid H₂SO₄ and/or ammonium sulfate (NH4)2SO4 . The acidic electrolyte 18 is run into the secondary compartment 14, or into all secondary compartments 14 when the stack has more than one repeating unit. On entering the secondary compartment 14 the acidic electrolyte 18 already comprises sulfuric acid and/or ammonium sulfate in order to be ionically conductive.

In the secondary compartment 14, sulfuric acid H₂SO₄ is additionally formed in the acidic electrolyte 18, thereby converting the acidic electrolyte 18 into aqueous sulfuric acid 19. The sulfuric acid H₂SO₄ concentration in the aqueous sulfuric acid 19 is higher than in the acidic electrolyte 18. The pH of the aqueous sulfuric acid 19 is accordingly higher than the pH of the acidic electrolyte 18. The aqueous sulfuric acid 19 is withdrawn from the secondary compartment 14. Depending on the sulfuric acid concentration reached in the aqueous sulfuric acid 19, this can be used directly as a secondary target product or is concentrated further, as described later.

The electrode rinse solution 20 is likewise an auxiliary medium, which is used to provide the water serving as a reactant at the electrodes 3, 4 and at the same time as an electrolyte. It comprises water and sulfuric acid and/or ammonium sulfate. The electrode rinse solution is run into the two electrode chambers 1, 2 so as to come into contact there with the electrodes 3, 4. The electrode rinse solution 20 is in particular withdrawn from a corresponding tank 21 and circulated through the two electrode chambers 1, 2 either serially or in parallel (not shown).

In order to obtain the primary target product, ammonia, the ammonia water 17 is transported to a stripper 22, where it is charged with a stripping gas 23, for example with nitrogen N₂ or air (not shown). Gaseous ammonia NH₃ is purged from the ammonia water 17 with the stripping gas 23, leaving behind an ammonia-depleted water 24. The stripping process can optionally also be carried out under vacuum, i.e. at a pressure below 1013 hPa.

The process of the invention allows four operating modes: batch, semi-batch, feed-and-bleed and single pass.

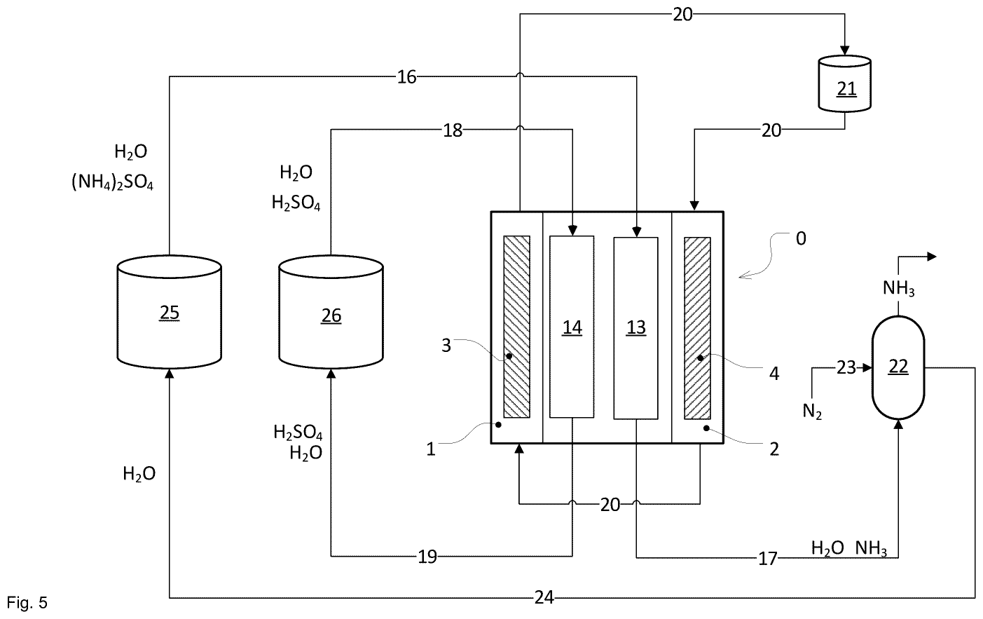

The batch principle is depicted in FIG. 5. In this case, the ammonium-sulfate-rich water 16 is provided in a primary reservoir vessel 25 and from there runs into the primary compartment 13 of the electrochemical cell 0. The ammonia water 17 withdrawn from the primary compartment 13 is freed from ammonia in the stripper 22, leaving behind ammonium-sulfate-depleted water 24. This is however run back into the primary reservoir vessel 25, where it mixes with the originally provided ammonium-sulfate-rich water. Consequently, the concentration of ammonium sulfate in the ammonium-sulfate-rich water 16 becomes ever lower over time. The pH of the ammonium-sulfate-rich water 16 also changes constantly, because the medium is cycled through the primary compartment 13, the stripper 22 and the primary reservoir vessel 25.

In batch operation, the composition of the ammonium-sulfate-rich water 16 is initially about 30-40% by weight (NH₄)₂SO₄ based on the total weight of the ammonium-sulfate-rich water. The initial pH is between 5 and 9. In the course of the process, the composition shifts to: (NH₄)₂SO₄, NH₃, H₂O, 9<pH<14, with a maximum possible proportion of NH₃ based on the residual proportion of NH₄⁺ determined by the dissociation equilibrium of the two substances. The pH values refer to measurement at 20°° C. using a glass electrode calibrated with a suitable test liquid.

In the batch operation depicted in FIG. 5, the acidic electrolyte/aqueous sulfuric acid is likewise cycled. For this, the acidic electrolyte 18 is provided in a secondary reservoir vessel 26 and from there runs into the secondary compartment 14. The aqueous sulfuric acid 19 withdrawn therefrom is run back into the secondary reservoir vessel 26. As a result, the concentration of sulfuric acid in the acidic electrolyte 18 increases continuously in the course of the process, as does the pH.

The starting value for the acidic electrolyte 18 is a concentration of approximately 1% by volume of H₂SO₄ and/or 0 to 50 g/L (NH₄)₂SO₄, based on the volume of the acidic electrolyte. In the course of the process, the composition shifts to: (NH₄)₂SO₄, H₂SO₄ 5% to 20% by volume, H₂O, 0<pH<7.

After a certain period of time, so much ammonia has formed in the process and been discharged that the concentration of ammonium sulfate in the primary reservoir vessel 25 is so low that the process cannot be operated economically any longer. The batch process is then ended. The secondary reservoir vessel 26 is where the concentrated sulfuric acid is held, which, alongside the ammonia, is the second target product of the process.

Instead of charging the batch process with the maximum concentration of ammonium-sulfate-rich water 16, it is possible to replace a portion of the contents of the primary reservoir vessel 25 with fresh ammonium-sulfate-rich water 27 after a certain period of time and thus obtain an ammonia-rich water 16 having a concentration resulting from the mixing ratio. The ammonia-rich water 16 run into the cell thus has at most the ammonium sulfate concentration of the fresh ammonium-sulfate-rich water 27. The concentration of ammonium sulfate in the ammonium-sulfate-rich water 16 falls until the cell is topped up with fresh ammonium-sulfate-rich water 27.

Similarly, a portion of the contents of the secondary reservoir vessel 26 (concentrated sulfuric acid H₂SO₄) can after a certain period of time be withdrawn and replaced with fresh water 28. This results in the pH of the acidic electrolyte 18 rising again.

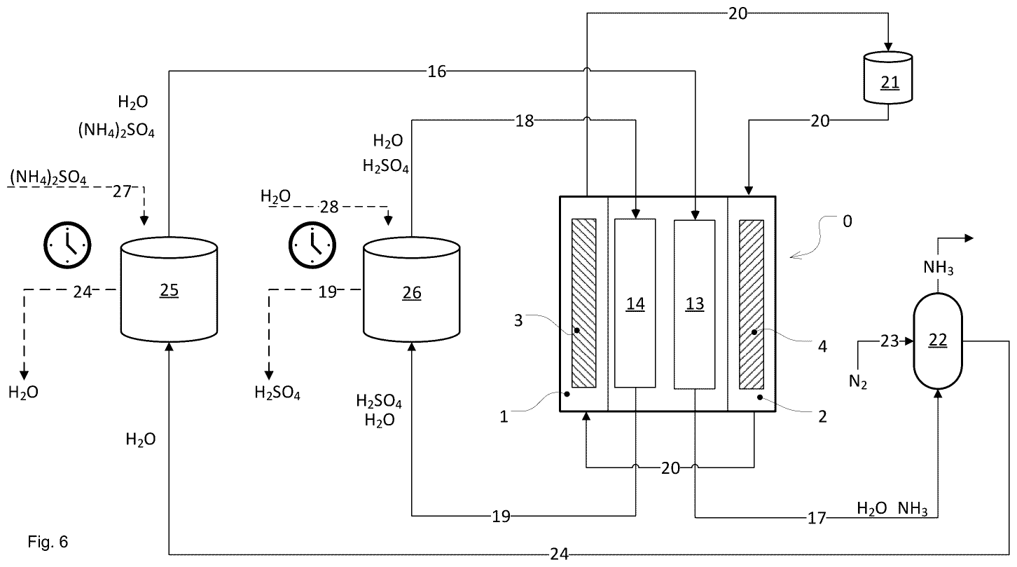

This mode of operation with partial replacement of the contents of the reservoir vessels 25, 26 is referred to as semi-batch and is outlined in FIG. 6.

Semi-batch operation uses the same ammonium-rich water 16 as the batch process, but the replacement of the media results in less extreme starting and/or end concentrations being attained. For example, the contents of the primary reservoir vessel can be partially replaced at: (NH₄)₂SO₄, NH₃, H₂O, 9<pH<14 and the secondary reservoir vessel diluted with water at NH₄)₂SO₄, H₂SO₄, H₂O, 0<pH<7.

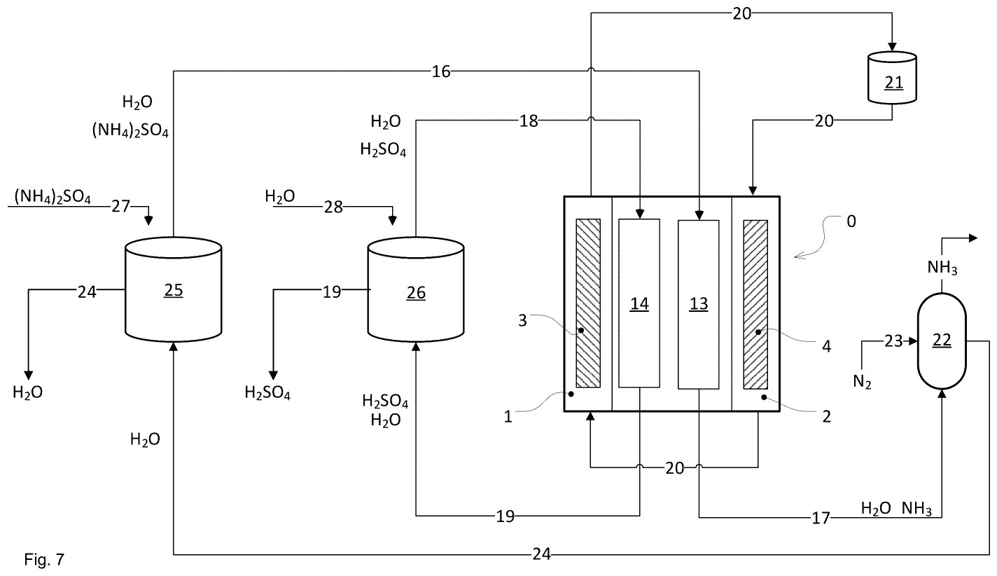

In a preferred embodiment of the invention, fresh ammonium-sulfate-rich water 27 is continuously run into the primary reservoir vessel 25, while ammonium-sulfate-depleted water 24 is continuously discharged from the process. As before, an ammonia-rich water 16 having a concentration resulting from the mixing ratio is formed. Similarly, aqueous sulfuric acid 19 is continuously withdrawn from the process and the primary reservoir vessel 26 topped up with fresh water 28. The aim here is to keep the pH in both reservoir vessels constant within a narrow window. This operating mode is termed feed-and-bleed. It is outlined in FIG. 7.

The chosen concentrations in feed-and-bleed mode are as follows:

In the primary reservoir vessel 25, the composition is set at: (NH₄)₂SO₄ between 0% and 40% by weight, 5.5<pH<14. The NH₃ concentration is kept as low as possible through being continuously withdrawn. The ammonia water 17 withdrawn from the primary compartment 13 then has the following composition: residual proportion (NH₄)₂SO₄ between 0% and 10% by weight, and with a maximum possible proportion of NH₃ based on the residual proportion of NH₄⁺ determined by the dissociation equilibrium of the two substances at 9.5<pH<14.

In feed-and-bleed mode, a constant operating point is established in the secondary reservoir vessel 26 through the addition of fresh water 28 and the discharge of processed “bleed”, that is to say aqueous sulfuric acid 19. In this case, a mixture of water, ammonium sulfate and sulfuric acid is established at a pH of between 0 and 7 in the secondary reservoir vessel 26. Specifying exact concentrations is not helpful here, because the concentrations depend on the dilution by the added water. The following composition is present at the outlet of the secondary compartment 14: H₂SO₄ between 0% and 20% by volume, H₂O, pH between 0 and 7.

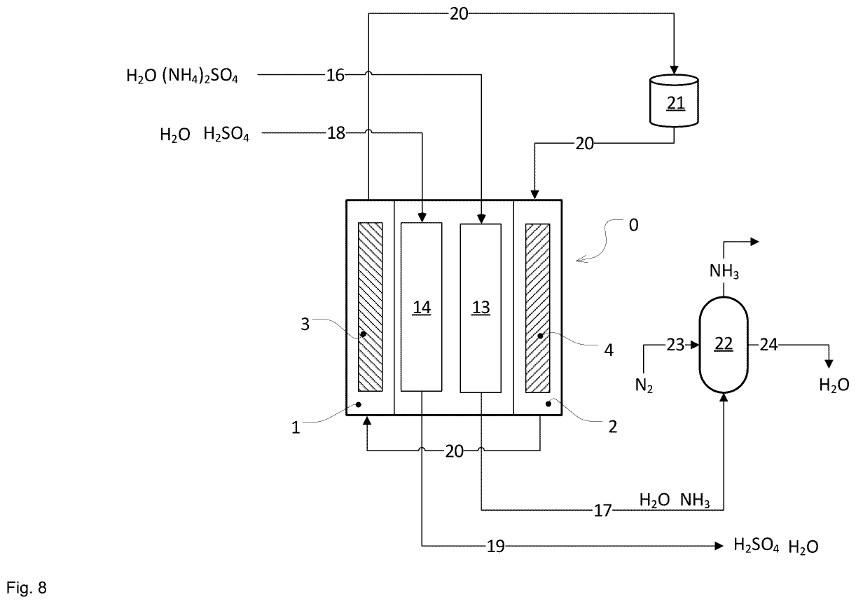

Instead of cycling through the two compartments 13, 14 in the batch, semi-batch and feed-and-bleed operating modes, it is also possible to discharge the respective media in one go (without recycling) through the compartments. This operating mode is termed single pass and is depicted in FIG. 8.

The chosen concentrations in single pass operation are as follows: In single pass operation, ammonium-sulfate-rich water 16 is run directly into the primary compartment 13 of the cell 0. The (NH₄)₂SO₄ concentration is then between 25% and 75% by weight or between 30% by weight and 40% by weight. The pH is between 5 and 9. At the outlet of the first compartment 13, ammonia water 17 having the following composition is withdrawn: (NH₄)₂SO₄ between 0% and 10% by weight, and with a maximum possible proportion of NH₃ based on the residual proportion of NH₄⁺ determined by the dissociation equilibrium of the two substances at a pH of between 9 and 14.

In the single pass process, the composition of the acidic electrolyte 18 is a concentration of approximately 1% by volume of H₂SO₄ and/or 0-50 g/L (NH₄)₂SO₄, based on the volume of the acidic electrolyte. The aqueous sulfuric acid withdrawn from the secondary compartment 14 in the single pass process has a pH of between 0 and 7 and an H₂SO₄ concentration of 5% to 20% by volume.

Of course, it is possible to mix the operating modes presented here, for example to run the first compartment in a cycle with feed-and-bleed and to run through the secondary compartment in single pass.

What all operating modes have in common is that the electrode rinse solution 20 is cycled through the tank and the two electrode chambers 1, 2. The reason for this is that the composition of the electrode rinse solution 20 scarcely changes. It contains water, sulfuric acid and/or ammonium sulfate and the pH of the electrode rinse solution, measured using a glass electrode at 20° C., is between 0 and 9.

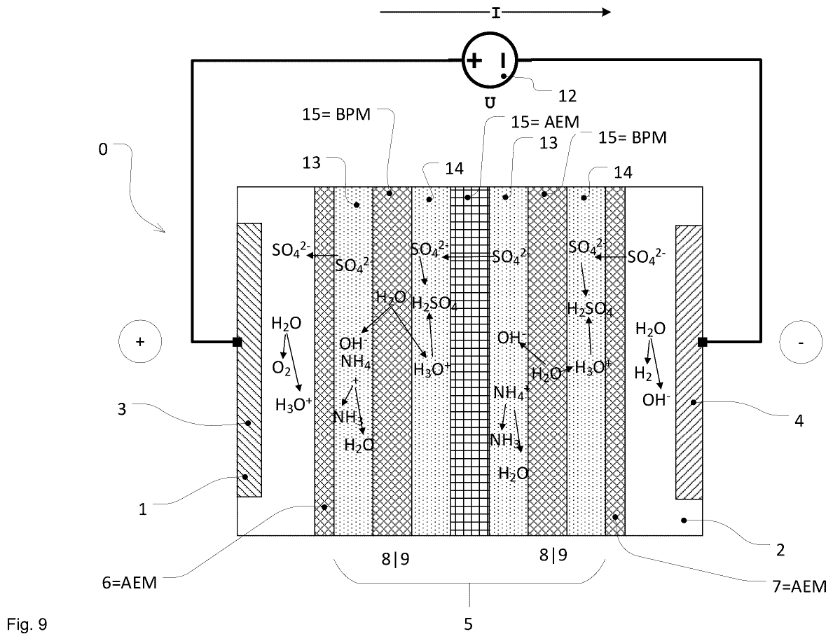

Lastly, the electrochemical processes expected in the cell 0 according to the common model concepts will be elucidated. FIG. 9 is used for this purpose.

The electrochemical cell 0 depicted in FIG. 9 has two repeating units R, n=2. The two end membranes 6, 7 are executed as anion-exchange membranes AEM. The separator 15 is also an AEM. The stack 5 of the cell 0 depicted in FIG. 9 thus corresponds to the one shown in FIG. 3B.

Because the process is operated with aqueous media, water H₂O is present in all compartments 13, 14 and electrode chambers 1, 2.

Additionally present in the first compartments 13 is ammonium sulfate (NH₄)₂SO₄, which had been introduced into the primary compartments 13 with the ammonium-sulfate-rich water 16. Since the ammonium sulfate is dissolved in the water, it is accordingly present in the form of its ammonium cation NH₄⁺ and its sulfate anion SO₄²⁻.

Additionally present in the second compartments 14 besides water is sulfuric acid H₂SO₄, which had been introduced into the secondary compartments 14 with the acidic electrolyte 18. Since the sulfuric acid dissociates in the water, it is accordingly present in the form of its oxonium cation H₃O⁺ and its sulfate anion SO₄²⁻. Since the electrode rinse solution 20 can comprise not just water, but also ammonium sulfate and sulfuric acid, the aforementioned ions can likewise be present in the two electrode chambers 1, 2.

Because the electrochemical cell 0 is charged with an electrical voltage U drawn from the electrical voltage source (not shown here), a corresponding electrical potential acts between the anode and the cathode. This causes the anions to migrate towards the anode 3, whereas it draws the cations to the cathode 4. During this process, the sulfate anions SO₄²⁻ are able to cross the anion-exchange membrane AEM. However, because the bipolar membranes BPM are arranged such that their negatively charged ion-exchange membrane 9 faces towards the cathode 4, the sulfate anions SO₄²⁻ are repulsed by the BPM. This results in the sulfate anions SO₄²⁻ accumulating on the cathode side of the bipolar membranes BPM, i.e. in the secondary compartments 14. Similarly, the ammonium cations NH₄⁺ are unable to cross the bipolar membranes BPM in the direction of the cathode 4 and accumulate in the primary compartments 13. The process of enriching particular anions and cations in dedicated compartments is referred to as electrodialysis.

In the process of the invention, an electrolysis of water H₂O to oxonium cation H₃O⁺ and hydroxide anions OH takes place in parallel to the electrodialysis. The water electrolysis is divided into an anode reaction (I) and a cathode reaction (II), which take place in the respective electrode chambers:

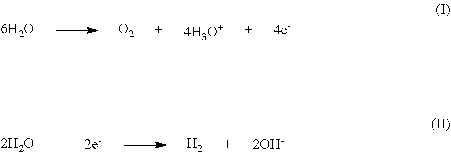

The electrolysis of water according to the two subreactions (I) and (II) is the variant of water electrolysis in neutral solution. When increasingly acidic conditions are present in the anodic electrode chamber 1 and anodic electrode chamber 2, the variant of water splitting in acidic solution can also take place (not shown). When the electrode rinse solution 20 is basic at the start of the process, a basic water splitting can also occur (not shown).

The hydrogen H₂ and oxygen O₂ gases formed in the water splitting are removed from the electrode rinse solution 20 and can either be used as materials in other processes or used to generate electricity in a fuel cell. The electricity obtained can be used to power the electrical voltage source. Removing the gases is easy, since they pretty much bubble out of the electrode rinse solution on their own. The sole important thing is to remove oxygen and hydrogen separately so that there is no explosion of explosive gas mixtures. None of this described in detail here, since the active surface area of the stack is much larger than that of the electrode chambers. The electrochemical effects in the stack significantly outweigh those in the electrode chambers. As a result, much more ammonia and sulfuric acid is formed than hydrogen and oxygen.

More relevant is a second water splitting that takes place within the bipolar membranes BPM. As already mentioned, the materials from which the bipolar membranes are made absorb water, consequently in the electrical potential at the interface of the BPM, water is likewise split into OH and H₃O⁺. The polarity of the BPM means that the hydroxide ions OH⁻ that are formed migrate to the primary compartments 13 arranged on the anode side of the BPM, while the oxonium cations H₃O⁺ migrate to the secondary compartments 14 on the cathode side of the BPM.

In the primary compartment 13, the water splitting is accompanied by the hydroxide ions OH-combining with the ammonium cations NH₄⁺ present there to form ammonia NH₃ according to equilibrium reaction (IV):

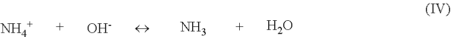

In the secondary compartment 14, the oxonium cations H₃O⁺ combine with the sulfate anions accumulating there to form sulfuric acid H₂SO₄ and water H₂O according to equilibrium reaction (V):

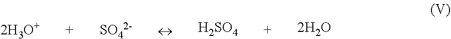

The sulfuric acid will dissociate in the water in its normal manner.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 23166752.8, filed Apr. 5, 2023, are incorporated by reference herein.

### Experiments

The effects achieved with the invention will now be examined experimentally. In this context, further details of the process of the invention will be disclosed.

### Experimental Setup and Procedure

### Material

The experiments employed the membranes listed in Table 2. Before being fitted, the membranes were immersed for at least 24 h in 10 g/L ammonium sulfate (Carl Roth GmbH+Co. KG, ≥99.5%, analytical grade).

TABLE 2
Membrane types

| | | Membrane |
|---|---|---|
| Manufacturer | Designation | type |
| Fuji | Type II | AEM |
| Ralex | AMHPP | AEM |
| Ralex | BM 3.1 | BPM |

The electrolyte solutions were in each case prepared with ammonium sulfate (Carl Roth GmbH+Co. KG, ≥99.5%, analytical grade) and sodium sulfate (Merck KGaA, Supelco, EMSURE) with demineralized water.

### Experimental Setup

The heart of the experimental setup is the cell stack, as depicted in FIG. 9, in the interior of the electrochemical cell. This consists of anion-exchange membranes (AEM), which allow only anions (in this case sulfate and/or hydroxide ions) and uncharged substances (in this case water and undissolved ammonia) to pass through, and bipolar membranes (BPM), in which water dissociates to OH⁻ and H₃O⁺ and through which only uncharged substances can pass. These membranes are arranged alternately (in the example AEM, BPM, AEM, BPM, AEM) and thus separate a basic cycle and an acidic cycle. Spacers (Deukum GmbH) provided with a sealing edge are fitted between the membranes and between the outermost membranes and the electrode chamber. The combination of a BPM and an AEM is referred to here as a repeating unit. Present in the two outer chambers are the electrodes at which water is split into H₂ and O₂. Flowing through these electrode chambers is the electrode rinse solution, which provides conductivity and transports away the gas that is produced. The dissolved ammonia is produced here in the basic cycle and sulfuric acid is produced in the acid cycle.

In the overall context the experimental setup comprises, as depicted in FIG. 5, the electrodialysis cell (ED cell, 17.5×17.5 cm² active membrane surface area, Deukum GmbH), the reservoir vessels, each having a pump (Verder Deutschland GmbH & Co. KG, V-MD20C-H for feed and acid, V-MD10 for electrode rinse solution) and an air stripper. The purpose of the air stripper is to expel from the basic electrolyte via an air flow the ammonia that is produced.

FIG. 5 does not show the rectifier used (FuG Elektronik GmbH, 0-150 V at 0-30 A) that supplies the ED cell with power.

### Experimental Procedure

The extraction of ammonia from wastewater with high ammonium sulfate concentrations requires an electrodialysis cell fitted with membranes in the following sequence: bipolar membrane (BPM)-anion-exchange membrane (AEM)-BPM. The cell is connected by silicone hoses to three reservoir vessels containing the feed, acid and electrode rinse. Three pumps circulate the solutions through the cell in three loops. The feed contains 0-350 g/L ammonium sulfate, the acid container and the electrode rinse each contain 0-50 g/L. In the feed loop downstream of the electrodialysis cell is an air stripper that removes the ammonia that is formed. In feed-and-bleed mode, liquid can be withdrawn from the loops via valves downstream of the cell and the air stripper.

The experiments were carried out in two different modes: once in “batch” mode and once in “semi-batch” mode, which at the same time simulates a “feed-and-bleed” mode with extended residence time.

The batch mode is achieved as follows:
1. Filling of the reservoir vessels
2. Circulating the liquids and purging air from the chamber and hoses
3. Applying a voltage to the electrodialysis cell
4. Running the ammonium depletion down to a feed conductivity of less than approx. 10 mS/cm

The experiment is then ended and the reservoir vessels are drained and rinsed. While the experiments are in progress, samples are regularly taken for ion chromatography measurements and the pH and conductivity are monitored.

The process steps in the semi-batch mode comprise:
1. Filling of the reservoir vessels
2. Circulating the liquids and purging air from the chamber and hoses
3. Applying a voltage to the electrodialysis cell
4. Running the ammonium depletion down to a feed conductivity of less than approx. 10 mS/cm
5. Withdrawing a portion of the feed (bleed mode)
6. Adding fresh feed
7. Repeating steps 4 through 6 until the desired feed solution has been purified.

Here too, samples are taken and measurements performed as described above.

### Ion Chromatography Measurements of the Ammonium Concentration

The ammonium concentrations in the samples were determined using an ion chromatograph from Metrohm. In this measurement procedure, a liquid sample is introduced into an eluent and passed through a column that has an ion-exchange resin coating. The interaction of the ion-exchange resin with the ions in the solution results in separation of the sample into its individual fractions, which are then quantified with a conductivity detector.

In this method, the pH of the samples must be adjusted to approximately 2 in order to prevent ongoing destruction of the ion-exchange resin coating. This results in conversion of the ammonia dissolved in the feed samples back into ammonium.

Thus it is always the total ammonium concentration that is measured. From the pH values recorded during the experiments, it is then possible to calculate back to the dissolved ammonia concentration using Equation 5:

$${c}_{ammonium , measured} / ( 1 + 10 \hat{} ( 9.5 - {pH}_{sample , exp} ) ) \qquad ( Eq . 5 )$$

9.5 is the pKa of an ammonium/ammonia solution at 20° C.

### Experimental Results and Discussion

To investigate the industrial practicability of the process, laboratory experiments with different stack compositions, starting media and starting concentrations, current densities and membranes were carried out. The focus here was on demonstrating the general feasibility, in addition to which the economic feasibility was also assessed. As an aid thereto, a Python model was used to simulate and investigate various factors influencing the scale-up of the system.

One factor that influences the feasibility of the process is water transport between the loops. The aim must therefore be a water balance that is as balanced as possible and a deficit due to water electrolysis only in the electrode rinse solution. Water transport is largely determined by the membranes used, the current density and the concentrations present. In addition, the dissolved ammonium sulfate must undergo reaction in the shortest possible residence time and the ammonia produced must undergo minimal diffusion into the “wrong” loops. This diffusion is influenced by the residence time and the membrane properties.

### Influence of the Selected AEM

In a comparison of two batch experiments with the same experimental conditions but different AEM membranes, what is immediately evident is the significantly different course of the filling levels of the reservoir vessels.

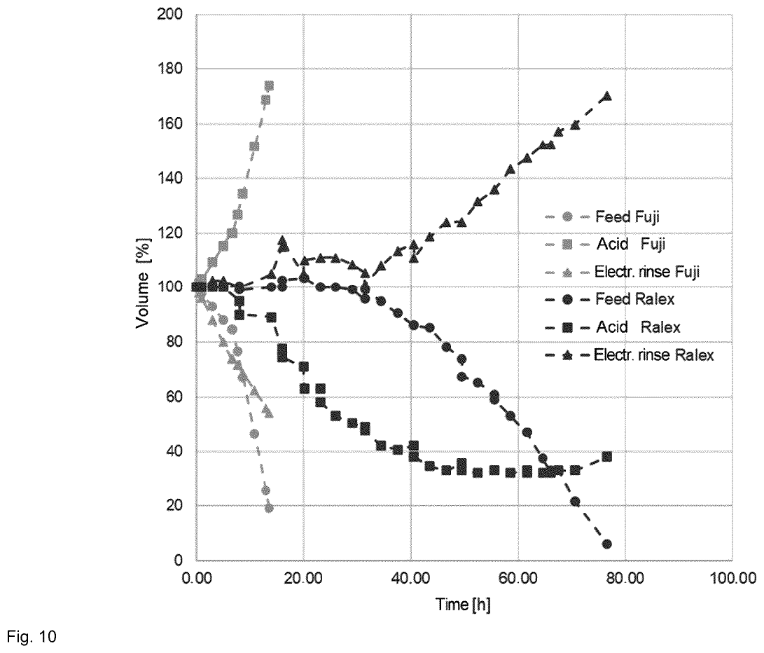

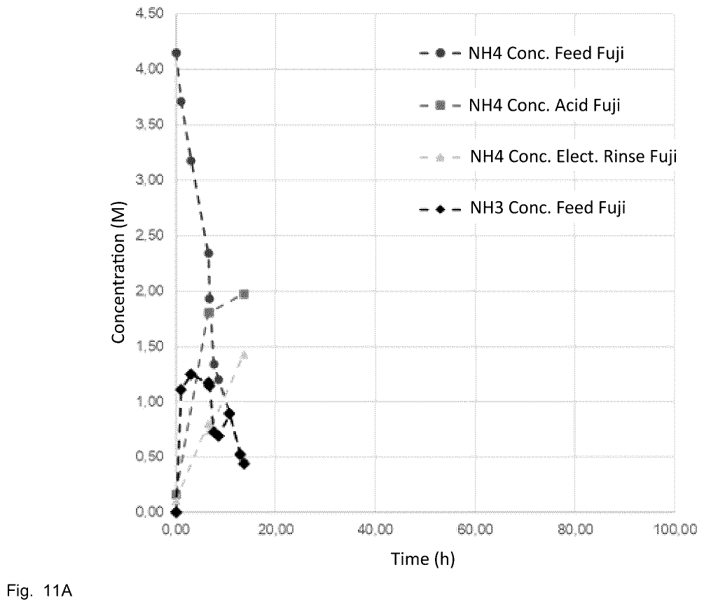

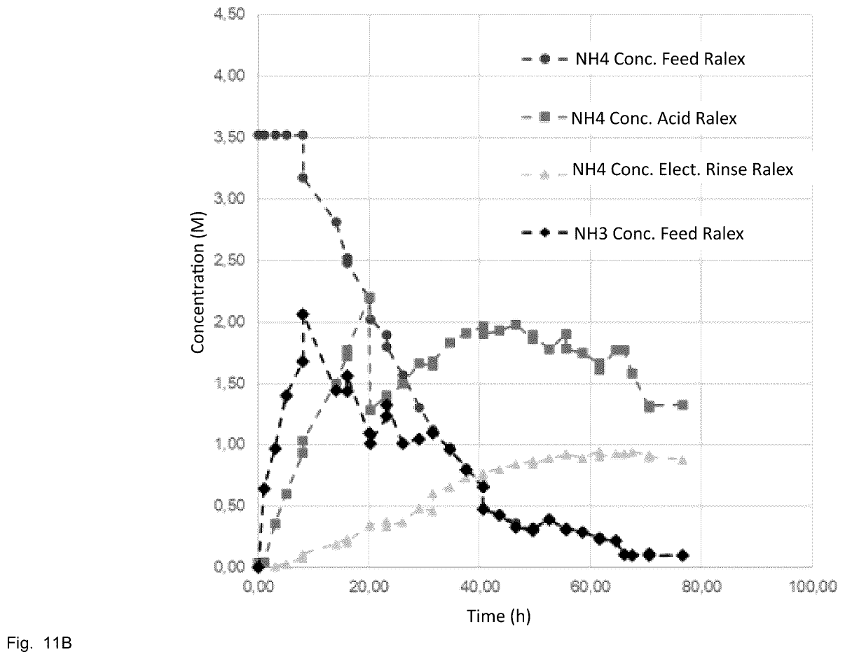

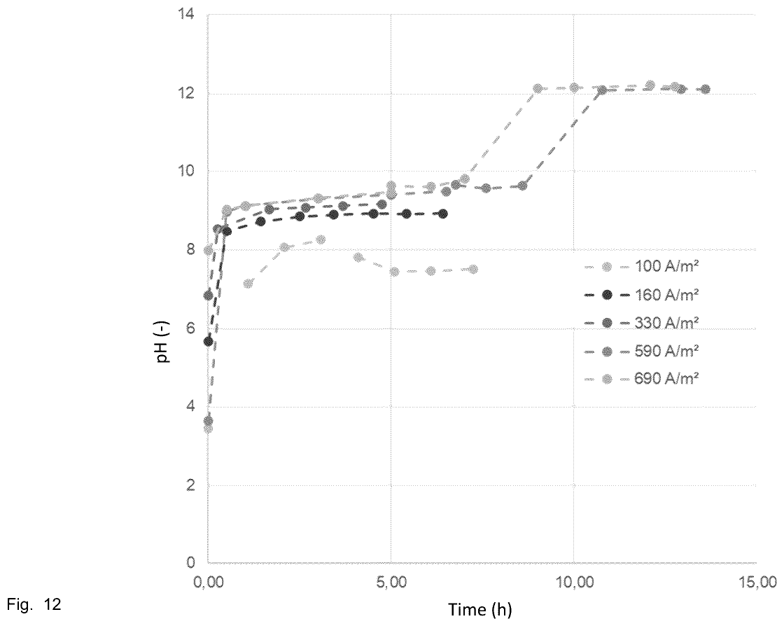

FIG. 10 compares the course of the filling levels over the experiment time of several days in an experiment with Fuji AEMs and BPMs with the course in an experiment with Ralex AEMs and BPMs.

FIG. 10: Comparison of the percentage change in volume in batch experiments with Fuji versus Ralex AEMs, with in each case two repeating units.

The experiments were carried out at 590 A/m². The starting concentrations used were: 350 g/L of ammonium sulfate in the feed, 0.5 g/L in the acid and 100 g/L of sodium sulfate in the electrode rinse solution.

In both experiments a voltage of 18 A (588 A/m²) was applied and the feed was filled with 350 g/L of ammonium sulfate, the acid with 0.5 g/L and the electrode rinse solution with 100 g/L of sodium sulfate. The volumes were normalized to the starting volume (100%) and the intermittent topping up with demineralized water or running-off of a portion of the solution was factored out.

FIG. 10 shows the experiment with Fuji membranes, in which an immediate increase in volume in the acid reservoir vessel from 100% to 174% can be seen within 14 h. After an experiment time of 6.75 h, the experiment was switched off overnight and a subsequent slight increase in the gradient was noted. The filling levels of the feed and of the electrode rinse solution behave in the opposite way to the acid during the same time interval. The feed volume falls to 19% and an increase in gradient is likewise noted, and the volume of electrode rinse solution falls to 54% without any change in gradient.

In the experiment with Ralex membranes, the course of all filling levels is relatively constant up to a time of approx. 8 h (one experiment day). The acid filling level thereafter falls to a minimum of 32% between 52.5 h and 66 h and after that rises again to 38% at 76.5 h. The feed filling level continues to show an approximately constant course until falling steadily from approx. 31.5 h, to 6% at 76.5 h. The filling level of the electrode rinse solution after a local maximum of 118% at 16 h starts to rise steadily at about the same time as the feed, to 170% at 76.5 h.

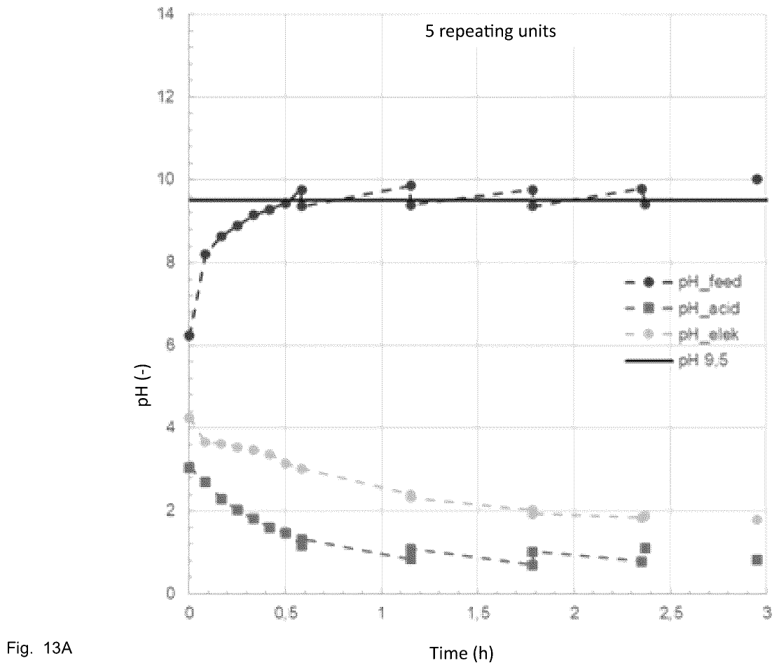

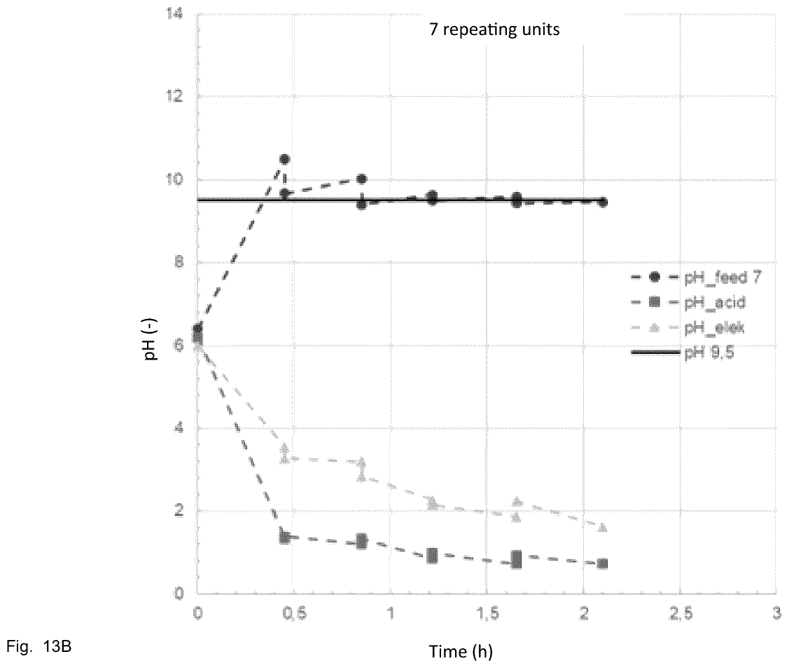

Differences can also be seen in the comparison of the concentration courses in FIG. 11.

FIG. 11: Comparison of ammonium and ammonia concentrations in batch experiments with Fuji versus Ralex AEM with in each case two repeating units.

The experiments depicted in FIG. 11 were carried out at 590 A/m². The starting concentrations used were: 350 g/L of ammonium sulfate in the feed, 0.5 g/L in the acid and 100 g/L of sodium sulfate in the electrode rinse solution.

Both experiments start at an ammonium concentration of approx. 4 mol/L in the feed, which is lower than the expected 5.30 mol/L of a 35% by weight solution on account of dilution with the water remaining in the dead volume of the structure. As described in the IC measurement methodology, the nature of the measurement here means that the measured ammonium concentration represents the total amount of ammonium and ammonia.

In the case of the Fuji membranes (graph A in FIG. 11), this concentration falls to 0.44 mol/L within 14 h, with a simultaneous rise in the ammonium concentrations in the acid to 1.97 mol/L and in the electrode rinse solution to 1.43 mol/L. From the course of the pH values, which is also recorded, it is possible to calculate by means of the Henderson-Hasselbalch equation the concentration of dissolved ammonia present in the feed. This starts at 0 mol/l, reaches a maximum of 1.42 mol/L at 3 h and thereafter overlaps from approx. 10.75 h with the total ammonium concentration. The latter means that all ammonium is present as ammonia.

In the experiment with the Ralex membranes (graph B in FIG. 11), the feed concentration likewise falls and reaches a value of 0.47 mol/L within 40.5 h, after which the concentration falls more gradually, to 0.1 mol/L after 76.5 h. The ammonium concentrations in the other reservoir vessels likewise reach local maxima: of 2.2 mol/L in the acid after 20 h and of 0.94 mol/L in the electrode rinse solution after 67.5 h. The ammonia dissolved in the feed starts at 0 mol/L, reaches a maximum of 2.06 mol/L at 8 h and thereafter falls and overlaps from 31.5 h with the total ammonium concentration.

The experiment with the Fuji membranes shows significantly lower membrane retention for water, which is transported by the high current density with the hydration envelopes of the ammonium ions. This flow would at first be opposed by a flow of water arising from the high osmotic pressure difference from the chambers with lower concentration (acid) to those with higher concentration (feed). However, the influence thereof is not discernible in this experiment. The steady loss of volume of the electrode rinse solution is to be expected during such a process, since water is steadily being converted into H₂ and O₂ in the electrode chambers. In addition, the membranes also show comparatively lower retention for ammonium ions and dissolved ammonia. The more rapid rise in the ammonium concentration in the acid and electrode rinse solution demonstrates this permeability. The dissolved and uncharged ammonia presumably diffuses almost unhindered through the membranes. This makes it desirable to have the shortest possible residence time and low ammonia concentrations; the amount of ammonia diffused depends on these factors.

The Ralex membranes by contrast show much higher resistance for water transport, as a consequence both of the high ionic current and the osmotic pressure difference. This is discernible from the only minimal change from the starting volumes. From approx. 8 h, an osmotic pressure-driven transport of water from the acid to the electrode rinse solution takes place as a result of the high concentration gradient. This is also an indication that the high concentration in the electrode rinse solution is being maintained. The abruptly commencing loss of volume in the feed solution coincides moreover with the complete conversion of ammonium to ammonia. Here too, the same conclusion can be drawn as regards the residence time and the ammonia concentration.

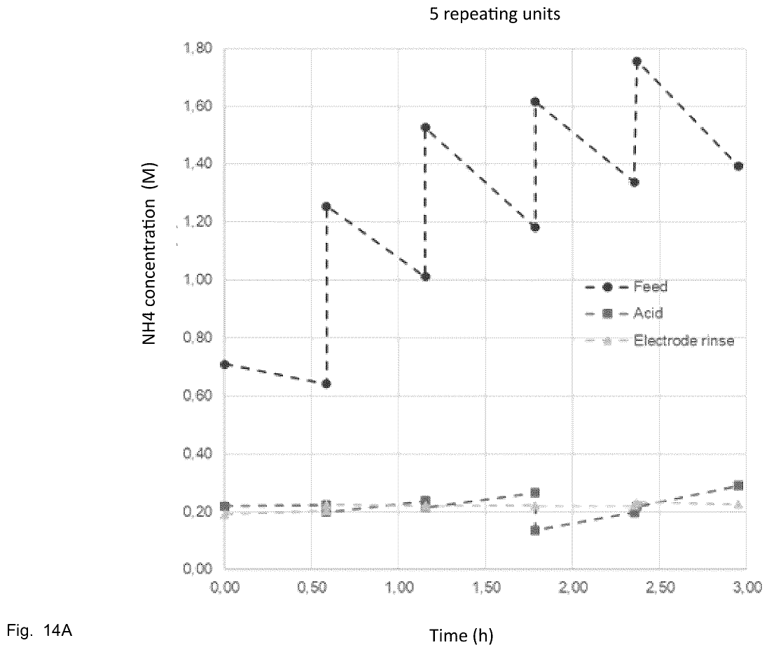

In an experiment with Fuji membranes at a fixed voltage of between 3 A (100 A/m²) and 18 A (590 A/m²), which varied between the experiments, the progression of the feed pH values was measured, see graph in FIG. 12.

FIG. 12: Comparison of the pH progression in batch experiments with Fuji AEMs with in each case two repeating units.

The starting concentrations used were: 350 g/L of ammonium sulfate in the feed, 0.5 g/L in the acid and 100 g/L of sodium sulfate in the electrode rinse solution.

The experiment at 100 A/m² shows a rise in pH to a maximum of 8.25 after approx. 3 h, after which it falls to 7.44 at approx. 7 h and thereafter shows just a slight rise to 7.51 at 7.25 h. The experiments with higher current densities show fundamentally different courses. Here, the pH rises quickly, within approx. 30 min, and thereafter shows only minor changes. Thus, at 160 A/m² the pH is 8.93 at approx. 6.5 h; at 330 A/m² it is 9.17 at 4.75 h; at 590 A/m² it is 9.64 at approx. 8.6 h and at 690 A/m² it is 9.81 at 7 h. In the latter two cases, a rapid, sudden rise in pH takes place thereafter, which after that remains broadly constant. At 590 A/m² to approx. 12.1 from 10.75 h and at 690 A/m² to approx. 12.2 from 9 h.

From these experiments it can be inferred that a higher current density also means a higher pH before complete ammonium conversion. Moreover, the pH jump in the two experiments with the highest current densities can be interpreted as being the time of complete ammonium conversion and would certainly take place in the other experiments too after enough time. However, because of the ammonia loss described above, we aim to achieve the shortest possible residence time and thus high current densities. Although the recorded jumps take place well after the times calculated from Faraday's law (approx. 4 h for 590 A/m² and approx. 3B h for 690 A/m²), this efficiency of conversion can be significantly increased by process adjustments and scale-up, as described later.

### Behaviour in Semi-Batch and Influence of the Number of Membranes

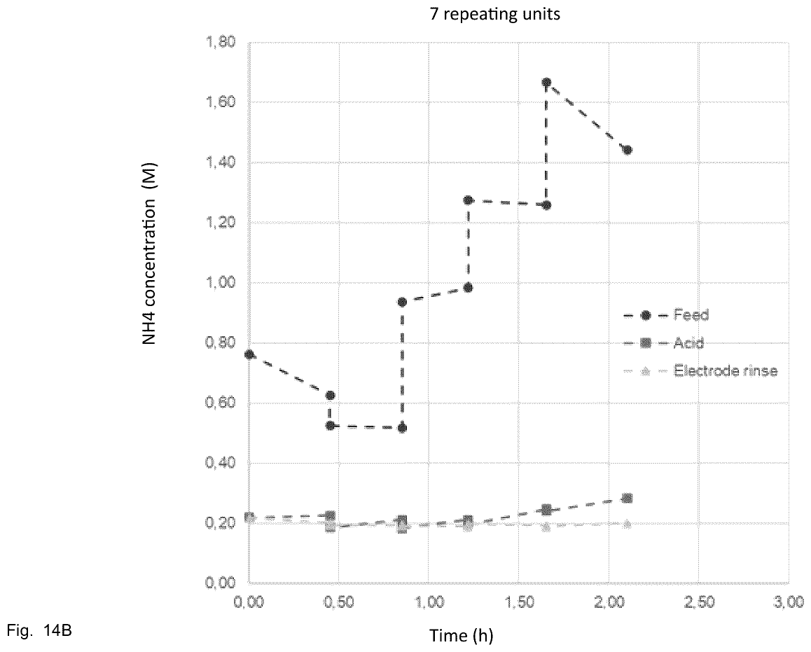

For scale-up, further data are required and the process needs to be operated as continuously as possible. Consequently, further experiments were carried out in semi-batch operation, as depicted in FIG. 13.

FIG. 13: Comparison of the pH progression between five and seven repeating units composed of Ralex AEMs and BPMs in semi-batch experiments.

The experiments were carried out at 590 A/m² and, if the conductivity of the feed fell below 10 mS/cm, a portion of the solution was replaced with fresh feed. The starting concentrations of ammonium sulfate used were: 50 g/L in the feed and 30 g/L in the acid and in the electrode rinse solution.

In addition, the initially charged concentrations were adjusted in order to simulate operation in feed-and-bleed mode, in which the ammonium-rich feed solution is continuously diluted and substituted with ammonium sulfate in all cycles. At the same time, the number of repeating units was increased to 5 and 7 respectively, in order to minimize the influence of the electrode rinse solution.

In the experiments shown here, the starting concentrations were 50 g/L in the feed and 30 g/L in the acid and in the electrode rinse solution. Both experiments were carried out at 590 A/m² (18 A). The experiments were run until the conductivity in the feed had fallen below 10 mS/cm. A portion of the solution was then replaced.

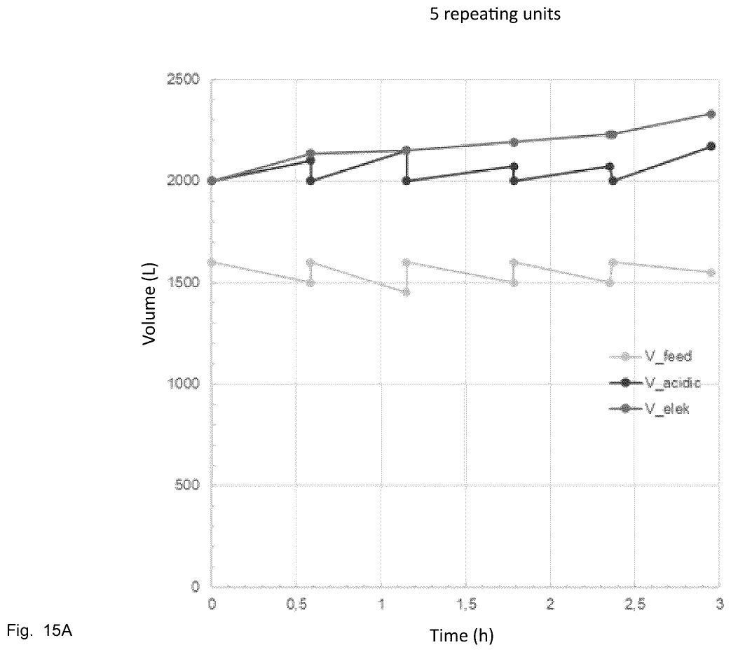

The course of the pH values is essentially similar in the two experiments. In the feed, the pH rises within approx. 30 min to 9.75 (5 repeating units, graph A in FIG. 13) or 10.5 (7 repeating units, graph B in FIG. 13). Thereafter, the pH is respectively maintained between 9.36 and 10.0 in A) and between 9.39 and 10 in B) by continuous replacement of 250 mL (approx. 16%) of the feed solution with 350 g/L ammonium sulfate solution when the conductivity fell below a threshold serving as an indicator for ammonium conversion. The pH of the acid and of the electrode rinse solution at first falls to approx. 1.17 and 3.0 respectively in A) and 3.55 and 1.34 respectively in B) within approx. 30 min and thereafter continues to fall to approx. 0.69 and 1.78 respectively in A) and 0.73 and 1.86 respectively in B). The course of the ammonium concentrations is depicted in FIG. 14.

FIG. 14: Comparison of the ammonium concentrations between 5 and 7 repeating units composed of Ralex AEMs and BPMs in semi-batch experiments.

The ammonium concentrations (FIG. 14) show a rising course in the feed in both A) and B). Here, phases of ammonia conversion and discharge into the offgas via the air stripper alternate with the defined replacement of a portion of the feed solution.

In the experiment with five repeating units (FIG. 14, graph A), the initial feed concentration of 0.71 mol/L falls after 0.58 h to 0.6 mol/L and rises to 1.28 mol/L upon subsequent replacement. The subsequent fall is more pronounced. Here, the concentration falls to 1.01 mol/L at 1.15 h and is thereafter raised to 1.53 mol/L. This behaviour then repeats until the concentration finally falls to 1.39 mol/L after 2.95 h. The intervals between topping up and discontinuation are always approx. 35.4 min. The concentrations in the acid and in the electrode rinse solution remain largely constant at approx. 0.2 mol/L. Only the concentration in the acid shows a noteworthy fall to 0.13 mol/L at 1.78 h and thereafter rises to 0.29 mol/L at 2.95 h.

Similar behaviour can be seen with seven repeating units (graph B in FIG. 14). In the feed, the concentration falls from 0.76 mol/L to 0.63 mol/L after 0.46 h. A subsequent mix-up (it was replaced with water instead of with 350 g/L ammonium sulfate solution) resulted in a fall to 0.58 mol/L. In the following cycle, the concentration was however increased again to 0.94 mol/L after 0.85 h. This rose slightly over time to 0.98 mol/L after 1.22 h. Thereafter, the concentration increased through replacement and processing to 1.44 mol/L after the last fall at 2.1 h. The average time between intervals was about 25.2 min. In this experiment too, the concentrations in the acid and in the electrode rinse solution remained constant at approx. 0.2 mol/L, with the concentration in the acid increasing from 1.22 h, to 0.28 mol/L at 2.1 h.

The change in volume was also monitored as an important parameter for the feasibility of a continuous process.

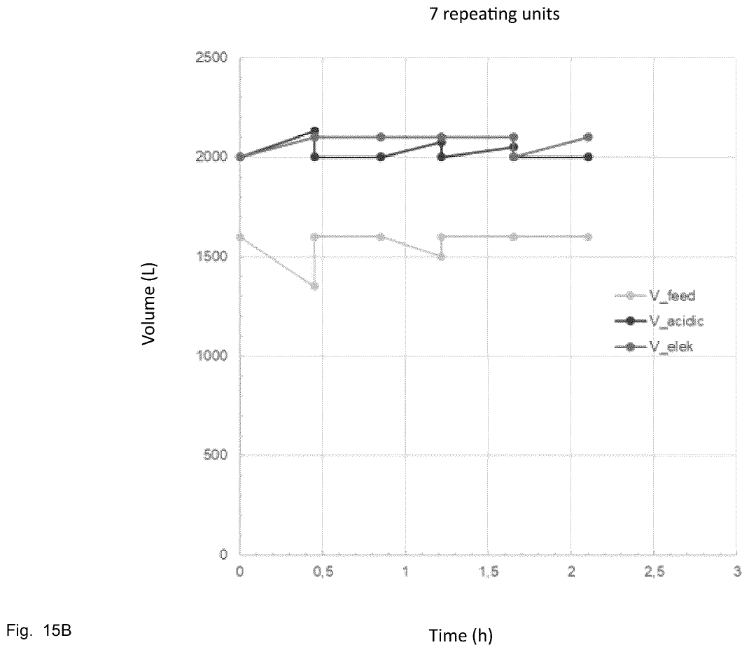

FIG. 15: Comparison of the volume progression between five and seven repeating units composed of Ralex AEMs and BPMs in semi-batch experiments.

In both experiments, as depicted in FIG. 15, the feed started at 1600 mL and the two other solutions started at 2000 mL each. The feed was topped up to the starting volume after each cycle as described above and the acid was run off to the starting value after an increase in volume. In the experiment with five repeating units (graph A in FIG. 15), a significant fall in the feed volume to approx. 1500 mL can be seen in each cycle. The acid increases to approx. 2100 mL each time. The electrode rinse solution increases continuously to 2330 mL after 2.95 h.

In the experiment with seven repeating units (graph B in FIG. 15), a more pronounced decrease in feed volume to 1350 mL is seen at first, after which the volume remains almost permanently at 1600 mL. In other words, it also did not need to be topped up again. In the acid the volume rises at first to 2130 mL and thereafter, except for two smaller rises, remains at approx. 2000 mL. The electrode rinse solution rises at first to 2100 mL and thereafter remains largely at this volume.

These experiments demonstrate first and foremost that more membranes mean more rapid conversion. This is because, with a higher number of membranes, more ions are transported in the same residence time at the same current density. Working against this is an increase in resistance and thus a higher voltage requirement. The smaller influence of the electrode rinse solution is also evident here, which is demonstrated by a proportionally lower resistance.

In the examination of the NH₄ concentrations and volumes, it can be seen firstly that adjusting the starting concentrations results in very few changes in the acid and the electrode rinse solution. This can be seen particularly clearly with more repeating units. In the feed, the volumes also show only little change, but a rise in the ammonium concentration is registered. This is explained by the laboratory setup used for stripping the ammonia failing to provide sufficient output and the ammonia accumulating with each pass. On an industrial scale, the plant must therefore be equipped with a commercial stripper of adequate proportions.

### Model Prediction for Further Operating Modes

For a pilot plant operated in feed-and-bleed mode, a simulation model based on estimating the resistance of the membrane stack and on the Faraday equation was additionally created. For this, the starting ammonium concentration was additionally estimated and ideal membrane behaviour assumed.

FIG. 7 shows an outline of such a setup. The pilot module has a larger active membrane surface area per membrane and in this example is operated with more repeating units.

Based on ideal assumptions, the lowest energy costs for the ammonia produced (without peripheral costs) that are achievable with the Ralex membranes were calculated here at 6.5 kWh/kg NH₃. These energy costs are comparable to literature values (3.9 kWh/kg NH₃, van Linden et al. 2019) obtained under laboratory conditions on a small scale. It is therefore to be expected that an even larger production plant will permit further energy savings.

### CONCLUSION

Through the use of only two membranes (BPM and AEM) instead of three membranes (with additional CEM), there is a smaller difference in concentration between cycles during the electrodialysis. This reduces disruptive water transport. This effect is also enhanced by a larger number of repeating units.

The feed-and-bleed mode has similar advantages: the concentration gradient between compartments is lower than with the conventional single pass mode. This reduces ammonia loss through the membranes and water transport.

The simulation of a feed-and-bleed pilot operation shows promising energy costs for the recovery of ammonia. A corresponding process appears viable on an industrial scale too.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### LIST OF REFERENCE SYMBOLS

0 Electrochemical cell
1 Anodic electrode chamber
2 Cathodic electrode chamber
3 Anode
4 Cathode
5 Stack
6 Anodic end membrane
7 Cathodic end membrane
8 Positively charged ion-exchange membrane
9 Negatively charged ion-exchange membrane
10 First electrical lead
11 Second electrical lead
12 Voltage source
13 Primary compartment
14 Secondary compartment
15 Separator
16 Ammonium-sulfate-rich water
17 Ammonia water
18 Acidic electrolyte
19 Aqueous sulfuric acid
20 Electrode rinse solution
21 Tank for electrode rinse solution
22 Stripper
23 Stripping gas
24 Ammonia-depleted water
25 Primary reservoir vessel
26 Secondary reservoir vessel
27 Fresh ammonium-sulfate-rich water
28 Fresh water
AEM Anion-exchange membrane
CEM Cation-exchange membrane
BPM Bipolar membrane
(+) Positive terminal
(−) Negative terminal
R Repeating unit
n Number of repeating units
S Number of separators
k Number of compartments
a Number of separators executed as AEM
b Number of separators executed as BPM
N₂ Nitrogen
H₂ Hydrogen
O₂ Oxygen
NH₃ Ammonia
H₂SO₄ Sulfuric acid
H₂O Water
(NH₄)₂SO₄ Ammonium sulfate
NH₄⁺ Ammonium cation
SO₄²⁻ Sulfate anion
OH⁻ Hydroxide anion
H₃O⁺ Oxonium cation

1. Process for producing ammonia and aqueous sulfuric acid from ammonium-sulfate-rich waters, having the following non-chronological steps:
a) providing at least one electrochemical cell having the following features:
i) the electrochemical cell includes an anodic electrode chamber in which an anode is arranged;
ii) the electrochemical cell includes a cathodic electrode chamber in which a cathode is arranged;
iii) the electrochemical cell includes a stack having the following structure:
the stack has repeating units, the number of repeating units is exactly n, where n is a natural number;
the stack has primary compartments, the number of primary compartments is exactly n;
the stack has secondary compartments, the number of secondary compartments is exactly n;
the stack has separators, the number of separators is exactly s,
where s is calculated as follows: s=2*n−1;
the primary and secondary compartments are arranged alternately in the stack and are each separated from one another by a separator;
each separator is either an anion-conducting membrane or a bipolar membrane;
the number a of separators that are an anion-conducting membrane is determined as follows:
a=1 when n=1, and a=n−1 when n>1;
the number b of separators that are a bipolar membrane is determined as follows:
b=0 when n=1, and b=n when n>1;
when n>1, the separators that are an anion-conducting membrane and the separators that are a bipolar membrane are arranged alternately within the stack;
each primary compartment is arranged on the anode side of an adjoining bipolar membrane, where the adjoining bipolar membrane does not need to be part of the stack;
each secondary compartment is arranged on the cathode side of an adjoining bipolar membrane, where the adjoining bipolar membrane does not need to be part of the stack;
iv) the electrochemical cell includes two end membranes, the first end membrane being arranged between the stack and anodic electrode chamber, the second end membrane being arranged between the stack and the cathodic electrode chamber, both end membranes being identically selected from the group consisting of the following membrane types: anion-conducting membrane, cation-conducting membranes, bipolar membrane;
v) each bipolar membrane is arranged in the electrochemical cell such that its positively charged portion is facing towards the anode, while its negatively charged portion is facing towards the cathode;
b) providing an electrical voltage source;
c) providing an ammonium-sulfate-rich water comprising water and ammonium sulfate;
d) providing an acidic electrolyte comprising water and sulfuric acid;
e) providing an electrode rinse solution comprising water, sulfuric acid and/or ammonium sulfate;
f) charging the primary compartments of the electrochemical cell with the ammonium-sulfate-rich water;
g) charging the secondary compartments of the electrochemical cell with the acidic electrolyte;
h) rinsing the electrode chambers with electrode rinse solution;
i) charging the electrochemical cell with an electrical voltage drawn from the electrical voltage source such that there is an electrical potential between the anode and the cathode;
j) discharging ammonia water from the primary compartments of the electrochemical cell;
k) discharging aqueous sulfuric acid from the secondary compartments of the electrochemical cell;
l) removing ammonia from the ammonia water, affording an ammonia-depleted water.

2. Process according to claim 1, characterized in that the electrochemical cell has exactly one anodic electrode chamber, exactly one cathodic electrode chamber, exactly one stack and exactly two end membranes, and that the first end membrane directly adjoins the stack and anodic electrode chamber and that the second end membrane directly adjoins the stack and cathodic electrode chamber.

3. Process according to claim 1, characterized in that the stack consists of the compartments and separators listed in claim 1.

4. Process according to claim 1, characterized in that at least one compartment and/or at least one electrode chamber is spanned by a spacer.

5. Process according to claim 1, executed in a system comprising a large number of electrochemical cells connected to the electrical voltage source in parallel.

6. Process according to claim 1, characterized in that the ammonia is removed from the ammonia water by stripping with air or nitrogen.

7. Process according to claim 1, characterized in that the ammonia is removed from the ammonia water at a pressure of between 0 hPa and 1013 hPa.

8. Process according to claim 1, executed in an operating mode selected from the group of the following operating modes: batch, semi-batch, feed-and-bleed and single pass.

9. Process according to claim 8, executed in batch operating mode, characterized in that the ammonium-sulfate-rich water is provided in a primary reservoir vessel, and that the ammonia-depleted water is transported to the primary reservoir vessel;
and/or that the acidic electrolyte is provided in a secondary reservoir vessel, and that the aqueous sulfuric acid is transported to the secondary reservoir vessel.

10. Process according to claim 8, executed in semi-batch operating mode, characterized in that the ammonium-sulfate-rich water is provided in a primary reservoir vessel, that the ammonia-depleted water is transported to the primary reservoir vessel, and that a portion of the contents of the primary reservoir vessel is from time to time withdrawn and replaced with fresh ammonium-sulfate-rich water;
and/or that the acidic electrolyte is provided in a secondary reservoir vessel, that the aqueous sulfuric acid is transported to the secondary reservoir vessel, and that a portion of the contents of the secondary reservoir vessel is from time to time withdrawn and replaced with fresh acidic electrolyte or water.

11. Process according to claim 8, executed in feed-and-bleed operating mode, characterized in that the ammonium-sulfate-rich water is provided in a primary reservoir vessel, that the ammonia-depleted water is transported to the primary reservoir vessel, and that a portion of the contents of the primary reservoir vessel is continuously withdrawn and replaced with fresh ammonium-sulfate-rich water;
and/or that a portion of the ammonia-depleted water is ahead of transportation to the primary reservoir vessel continuously withdrawn and replaced with fresh ammonium-sulfate-rich water;
and/or that the acidic electrolyte is provided in a secondary reservoir vessel, that the aqueous sulfuric acid is transported to the secondary reservoir vessel, and that a portion of the contents of the secondary reservoir vessel is continuously withdrawn and replaced with fresh acidic electrolyte or water
and/or that a portion of the aqueous sulfuric acid is ahead of transportation to the primary reservoir vessel continuously withdrawn and replaced with fresh acidic electrolyte or water.

12. Process according to claim 8, executed in single pass operating mode, characterized in that fresh ammonium-sulfate-rich water is continuously provided and ammonia-depleted water continuously discharged;
and/or that fresh acidic electrolyte is continuously provided and aqueous sulfuric acid continuously discharged.

13. Process according to claim 10, characterized in that the fresh ammonium-sulfate-rich water contains ammonium sulfate in a concentration of between 30% and 40% by weight based on the mass of the fresh ammonium-sulfate-rich water, where the pH of the fresh ammonium-sulfate-rich water measured using a glass electrode at 20° C. is between 5 and 9.

14. Process according to claim 1, characterized in that the electrode rinse solution is provided in a rinsing tank, and that the electrode rinse solution is continuously circulated from the rinsing tank into the two electrode chambers and from there back into the rinsing tank.

15. Process according to claim 14, characterized in that the electrode rinse solution is passed successively through one electrode chamber and then through the other electrode chamber.

16. Process according to claim 14, characterized in that the pH of the electrode rinse solution is continuously monitored, with water and/or sulfuric acid metered in if the nominal pH is exceeded and/or water and/or ammonium sulfate metered in if the pH falls below it.

17. Process according to claim 14, characterized in that the filling level of the rinsing tank is continuously monitored, with electrolyte rinse solution run off if the nominal filling level is exceeded and/or water and/or sulfuric acid and/or ammonium sulfate metered in if the filling level falls below it.

18. Process according to claim 8, characterized in that the filling level of at least one reservoir vessel is continuously monitored, with ammonium-sulfate-rich water or acidic electrolyte run off if the nominal filling level is exceeded and/or water and/or sulfuric acid and/or ammonium sulfate metered in if the filling level falls below it.
